(19) United States
(12) Patent Application Publication
(10) Pub. No.: US 2025/0383646 A1
(43) Pub. Date: Dec. 18, 2025

(54) METHOD AND SYSTEM FOR THE SEMI-AUTOMATIC AND AUTOMATIC CALIBRATION OF SUBTRACTIVE FABRICATION MACHINES

(71) Applicant: Patrick Baudisch, Berlin (DE)

(72) Inventors: Patrick Markus Baudisch, Berlin (DE); Martin Justus Taraz, Potsdam (DE)

(21) Appl. No.: 19/261,990

(22) Filed: Jul. 7, 2025

Related U.S. Application Data
(63) Continuation-in-part of application No. 18/835,622, filed on Aug. 2, 2024.
(60) Provisional application No. 63/306,035, filed on Feb. 2, 2022.
(60) Provisional application No. 63/362,657, filed on Apr. 7, 2022.
(60) Provisional application No. 63/667,804, filed on Jul. 4, 2024.

(51) Int. Cl. G05B 19/401

(52) U.S. Cl. CPC G05B 19/401; G05B 2219/31304; G05B 2219/37129; G05B 2219/37222; G05B 2219/45041

(57) ABSTRACT

A calibration subsystem comprising: a control system that provides a control signal to a fabrication machine to process a sample of a workpiece, at least one sensor sensing the effect that the processing had on the sample, wherein the control system computes the difference between the sensed effect and a desired effect, and the control system, in accordance with the difference, updates settings of the subtractive fabrication machine and/or of one or more models to be cut subsequently.

### 1 RELATED APPLICATIONS

This application claims the benefit of U.S. provisional patent application serial number 63/667,804 filed on Jul. 4, 2024, which is incorporated by reference herein in their entirety. This application is a continuation-in-part patent application of U.S. non-provisional patent application Ser. No. 18/835,622 filed on Aug. 2, 2024, which is a 371 of Patent Cooperation Treaty (PC) International Application claiming the benefit of U.S. provisional patent application serial number 63/306,035 filed on Feb. 2, 2022 and U.S. provisional patent application serial number 63/362,657 filed Apr. 7, 2022, which are incorporated by reference herein in their entirety.

### 2 BACKGROUND

In our PCT application PCT/US2023/012244 titled “Automatic Calibration for Subtractive Fabrication Machines”, we introduced a system that allows inexperienced users to calibrate fabrication machines, in particular subtractive fabrication machines, such as laser cutters and milling machines. The invention addresses the fact that fabrication machines tend to produce low-quality results unless users perform a lengthy manual calibration process. This process is typically poorly defined, varies according to what users are planning on cutting, and thus requires significant expertise. This prevents non-experts from performing such calibrating. Non-experts thus find themselves forced to accept that their output will be of low quality—e.g., non-expert use cases, such as in education, maker spaces, fab labs, etc. In the PCT/US2023/012244 application we therefore disclosed a process intended to simplify the calibration process.

### 3 SUMMARY OF THE INVENTION

In the present disclosure, we disclose (1) a particularly efficient 4-step calibration process, (2) an algorithm implementing it, (3) an algorithm that manages the dependencies between the steps of the calibration process (aka gauges), (4) we extend to automated and semi-automated calibration, (5) we disclose additional calibration aides (aka gauges), (6) we disclose an algorithm that optimizes the calibration process in light of the specific model to be fabricated, (7) a way to apply the calibration on models that are described in a 2D format, as well as (8) services enabled by the availability of the disclosed calibration systems, such as remote cutting, and (9) a service brokering platform.

The disclosed process proceeds as follows: In their design application, users pick a model to fabricate. Our system responds by generating a set of calibration aides for this specific model, which we refer to as gauges. Each gauge cuts from the same material users are planning on using for the model (some embodiments embed the gauges into spare regions of the material for the model, aka the “workpiece”). With or without the help of the user, the system then analyzes how the gauges have come out, infers how the model/the laser cutters settings need to be adjusted as a result of these gauges, and applies these not just to the model, but also to all subsequent gauges. When all gauges are done, the proposed embodiments fabricate the now well-calibrated model.

We have implemented these new concepts in a system we call Kalibrator. Among other aspects, Kalibrator demonstrates how to embed the proposed calibration process into the export pipeline of subtractive fabrication machines and/or applications, how to generate sequences of calibration steps optimized specifically for a model at hand, how to adjust model parameters and cutter settings accordingly, to then fabricate models of high quality.

The present invention offers two key benefits for users (1) It “lowers the bar”, i.e., allows a much wider range of non-experts to calibrate, thus achieve high-quality results. This reduces the necessity to recruit expert technicians, thus drastically lowers the total cost of ownership of subtractive fabrication machinery. This benefit is achieved by fully automated embodiments, as well as by semi-automatic embodiments, which merely guide users through the process. (2) Even when an expert technician should be available, the present invention speeds up the calibration process, thus saving labor and cost.

### 4 BRIEF DESCRIPTIONS OF THE DRAWINGS

FIG. 1: The user's objective is to make drawers that fit a specific cupboard.

FIG. 2: In our example, the user fabricates a simple drawer.

FIG. 3: Our system Kalibrator

FIG. 4: Flowchart depicting how the system interprets the effect of cutting had on a gauge

FIG. 5: Flowchart depicting how the system applies calibration information to model and fabrication machine

FIG. 6: Calibrating for the birch+acrylic drawer can be achieved for example using these 6 gauges.

FIG. 7: The second drawer, shown in the front, cut well and came out to specification, even though it was made from significantly thicker (6.5 mm vs. 4 mm) material.

FIG. 8: Expert users may invoke the step-by-step interface.

FIG. 9: Kalibrator starts processing the drawer model by identifying the 3 features that may require calibration.

FIG. 10: Flowchart depicting how the system extract features

FIG. 11: Excluding features from calibration using “:” menu.

FIG. 12: Flowchart depicting how the present invention optimizes the order of features so as to minimize the number of times users have to swap materials during calibration.

FIG. 13: Flowchart depicting how the present invention maps features to gauges

FIG. 14: During gauge mapping, the present invention replaces each feature (FIG. 9) with a gauge capable of calibrating the feature.

FIG. 15: This diagram reads right-to-left: During gauge expansion this box joint gauge (a) first expands by adding a cutting gauge and then (b) by adding a thickness gauge.

FIG. 16: Flowchart depicting how the present invention manages dependencies between gauges

FIG. 17: The step-by-step interface (a) rearranges the features into a vertical layout, then (b) expands them into gauges.

FIG. 18: Deduplication preserved only the first occurrence of a gauge while deactivating all subsequent occurrences.

FIG. 19: Flowchart depicting how the present invention deduplicates gauges

FIG. 20: Cutting gauge (a) as shown earlier, (b) designed for fast use, and (c) for minimum material use.

FIG. 21: (a) T-joints offer two degrees of freedom, thus Kalibrator calibrates in two steps: (b) length and (c) width of slots.

FIG. 22: (a) Cross joints as used for the legs of the chairs come in different depths. Some embodiments may thus offer (b-c) cross joint gauges of different depths (rotate the handle piece so it be orthogonal the strip on the left).

FIG. 23: (a) This geometric pattern requires (b) calibrating marking darkness. (c) If one wanted to express the number in terms of depth, we would calibrate engraving depth instead.

FIG. 24 (a) This HingeCore (Muhammad Abdullah et al. 2022. HingeCore: Laser-Cut Foamcore for Fast Assembly. In Proceedings of the Symposium on User Interface Software and Technology (UIST '22), 1-13) model requires calibrating not only cutting power, but also (b) cutting through the top paper and foam layers in order to create “finger hinges”, as well as (c) incisions that allow bending the material.

FIG. 25: Flowchart describing the algorithm for making a gauge

FIG. 26: Flowchart running gauges

FIG. 27: Kalibrator's test folder contains multiple test files.

FIG. 28: Each test contains an image, a manifest, and a test strip.

FIG. 29: The manifest of a .tst file, here a boxJointFit test. <add min and max kerf or some other description of distribution>

FIG. 30: Dependencies between kalibrator's default tests.

FIG. 31: (a) To fabricate this HingeCore model, the user creates custom tests that calibrate (b) cutting through the top paper and foam layers in order to create finger hinges, as well as (c) incisions that allow bending the material.

FIG. 32: Cutting tests designed to optimize (a) for speed (b) and for material use.

FIG. 33: (a) T-joints map to a boxJointFit test and then a tJointFit test. (b) To enable photo engravings, kalibrator complements markingDarkest and markingLightest with a marking-Gamma test, that reads multiple parameters.

FIG. 34: Cutplan represents the shown box joints by subtracting rectangles from a plate.

FIG. 35: Flowcharts of selected alternative orders of the gauge selection algorithm

FIG. 36: A flowchart teaching one method for calibrating a model contained in a 2D data format by invoking autoAssembler (or assembler3).

FIG. 37: Running Kalibrator on a 2801 tablet device placed next to the 2802 laser cutter

FIG. 38: Flowchart of how to read a gauge using a camera

FIG. 39: Example of one possible user interface that allows users to pick how many locations to sample.

FIG. 40: Touch-probe-like device that senses material stiffness by forcing a probe into the workpiece.

FIG. 41: Annotating a joint with a specific assembly force in an interactive editor

FIG. 42: Flowchart explaining the design-to-fabrication workflow, based on a model containing a specification of outcome

FIG. 43: With calibration in place, fabrication machines become interchangeable, here allowing users to pick a laser cutter, including a laser cutter elsewhere.

FIG. 44: One example user interface for a site connecting users who need a model cut with vendors willing to cut and ship.

FIG. 45: Process of sending a model to a vendor

### 5 DETAILED DESCRIPTION

### 5.1 Example Scenario

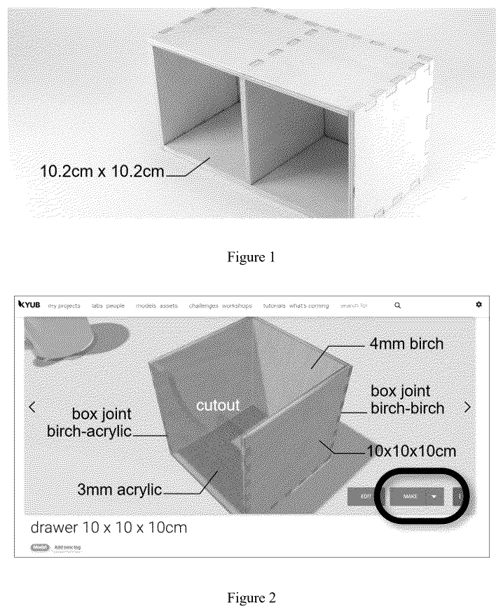

We will illustrate the present invention at a specific example, i.e., a user planning on making a simple pair of drawers, e.g., by laser cutting to fit the cupboard shown in FIG. 2, made from plywood. This example only serves the purpose of illustration—the user could make any other object (guitars, air planes, musical instruments, furniture, robotics . . . and so on) as long as this is supposed to be accomplished with the help of a subtractive fabrication machine that requires calibration.

The user will generally start by retrieving or create a model of such a drawer. As illustrated by FIG. 2, one possible way is to start by designing the drawer using a web-based design application (here kyub (kyub.com), flatFab (FlatFab.com), autoCAD, fusion360 (https://www.autodesk.de/products/fusion-360), onShape (https://www.onshape.com), or 2D construction/drawing tools, such as Adobe Illustrator, etc.). The shown drawer is quite simple: a cube-shaped box with a cutout in the front, which is made from acrylic, held together by box joints. The model would typically specify the dimensions of the model, such as width and height, but also materials, material thicknesses, and so on.

The shown demo model happens to contains 6 types of details, the dimensions of which are relevant for the project to succeed. In addition to the usual expectations, i.e., (1) we want the material to be cut through, (2) we want no burn marks, (3) we expect all box joints to be flush. (4) the box joints along the edges have to be tight enough to hold the box together, (5) the same applies to the box joints between the acrylic front plate and the plywood. (6) Finally, we need the box to adhere to the 10×10×10 cm+/−0.8 mm tolerance specification, in order to fit the cupboard and not to jam. Getting all of these 6 aspects right is the objective of calibration and, thus, of the present invention.

### 5.2 Calibrating and Cutting Using Kalibrator

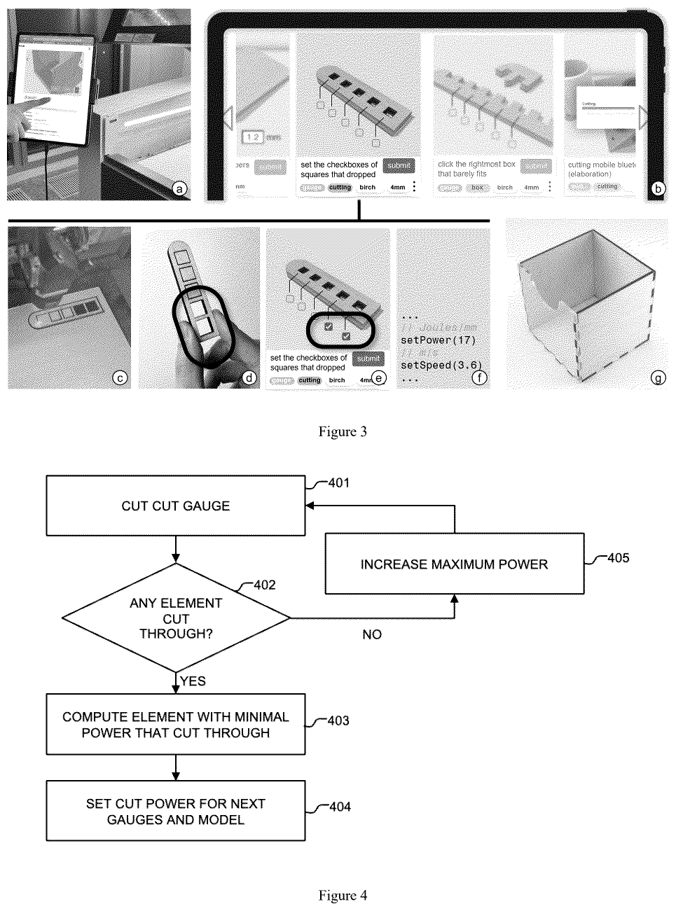

The range of possible user interfaces of the calibration system disclosed here varies according to whether the respective embodiment implements semi-automation or full automation. While a fully automated embodiment may use little or no user interface, semi-automatic systems receive input from the user, who's task it is, to read gauges and communicate the result to the system. FIG. 3 illustrates one possible user interface for a semi-automatic embodiment.

In the specific version shown in FIG. 3, users use a web-based design application (here, kyub (kyub.com)) to design or pick the model to fabricate. Users then invoke the fabrication of the model (here by clicking a “make” button, but any other invocation would work equally well).

(b) In the shown example, a call to the present invention is embedded into the modeling software, i.e., the present invention intercepts the call and inserts the calibration routine. Other embodiments may choose other types of invocation up to a complete separation of the editing system and the calibration system (see PCT/US2023/012244).

The present invention responds by generating a set of calibration aides (aka gauges) for this specific model. (c) The invention then cuts the gauges (or the software part of each gauge cuts “itself”) into the workpiece, here a spare region of it (other embodiments may choose to do this differently, such as cut into a dedicated piece of material, etc.).

The shown cutting power gauge features five cutouts, each of which the system cuts with a different level of power, e.g., arranged in the form of a geometric row, such as {2.1, 4.3, 8.5, 17, 34} of some scale (such as Joules/mm).

The main point of the gauges of the present invention is that they are designed to produce an effect on the material that either a user (semi-automatic) or an automatic sensor (such as a camera, a mechanical sensor, KerfMeter . . . ) can assess. In the shown example, the bottom two of the five cutouts were powerful enough to cut through the material—this is what contains the desired information about cutting power.

The number of elements, here cutouts, per gauge can conceptually be any number, including a small number, such as one, or a large number, say, in the dozens. Picking the number allows us to optimize speed on different systems; if starting a new cut takes more time, cut more at once; if starting a new cut takes little time (and one does not mind grabbing the user's attention), some embodiments may pick just a single cut. Fully automated systems may pick a small number, such as one.

(d) In a semi-automatic, as shown here, users may take the gauge out of the cutter or leave it inside and analyze it. In the shown design, the rounded tip of the gauge disambiguates the gauge's orientation but any such feature will do; other embodiments may resolve symmetry issues differently (by orientation, element arrangement, orientation in the machine, and so on).

(e) For a semi-automatic system, users analyze the gauge as directed by the system's user interface. Users then enter the result into the system. The shown embodiment uses a web interface for this purpose, but a wide range of user interfaces can be used for any of this (text-based, speech-based, gesture-based, camera-based, asynchronous by email or other communication service, on any device, and so on). In the shown embodiment, the user enters the information by clicking the two checkboxes corresponding to the two squares that were cut successfully. Other embodiments may pick different approaches, such as users just entering the number of the elements that dropped. While the shown embodiment cuts squares, other embodiments may pick different shapes, such as circles, cut shapes into the edge of material, attempt to cut a stick of material in half, and so on.

The proposed system now interprets this information (see Flowchart in FIG. 4). In this particular example, the fact that the last two cutouts dropped ({17, 34} Joules/mm) implies that the minimum required power lies below 17 Joules/mm. Some embodiments may use this information to calibrate for 17 Joules/mm as a lower bound; others may apply an additional fudge factor to account for irregularities in the fabrication machine and/or the material.

The system may increase precision by running additional gauges for the same parameter (here cutting power), e.g., sampling the interval in question in higher resolution, such as by sampling the space between 8.5 and 17 Joules/mm as {9.5, 10.7, 12, 13.5, 15.1} Joules/mm, and so on. This allows the system to achieve exponentially higher levels of precision.

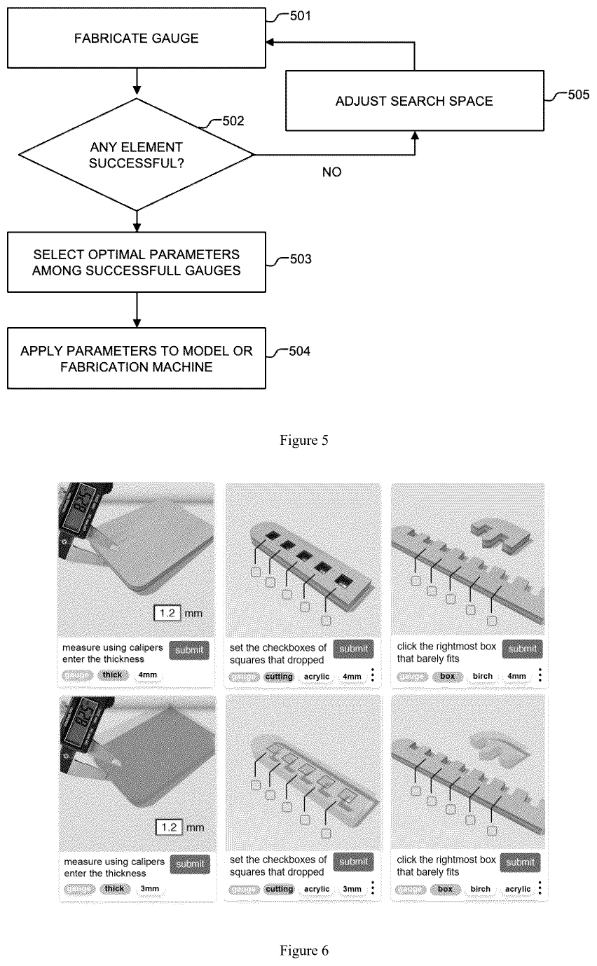

(f) The system may need to apply its calibration information not just to the model (see Flowchart in FIG. 5), but also the cutting of subsequent gauges may benefit from/require the information to be applied before calibration can proceed. The shown embodiment, for example, applies calibration information right away, allowing subsequent gauges to be executed with the settings determined by earlier gauges. This particular gauge adjusts the power settings of the laser cutter according to the results.

In the shown example, the cutting power gauge is now complete, and the system continues execution with the next gauge from the list shown in FIG. 3b. The next gauge in this example is a box joint gauge (inspired by “kerf strips”). The shown version requires users to insert a three-pin box joint into a strip of slots of increasingly tighter fits and select the first slot that fits.

FIG. 6 shows the complete set of gauges for this model. When all gauges are done, the system fabricates the now well-calibrated model.

As illustrated by FIG. 3g the resulting model is of high quality. It reflects the objectives set earlier, i.e., (1) the material cut through reliably, (2) there are no burn marks, and (3) all box joints are flush. Furthermore, the drawer respects the more specific requirements, i.e., (4) all box joints are tight, including (5) the box joints with the acrylic front plate, and (6) the box adheres to the 10×10×10 cm outer dimension and thus fits the cupboard.

5.3 The Proposed Approach Offers Flexibility

to illustrate the flexibility of our approach, we have the user cut a second drawer. Here the user accomplishes this by going back to the same model page shown in FIG. 2, and by hitting the “make” button again. Kalibrator displays the same process from FIG. 6. As before, the first step asks the user to measure the thickness of the material.

In our example, the user now realizes that there is not enough 4 mm birch plywood left. However, some of the 6.5 mm plywood, that the cupboard was made from, is left. Even though this material is thicker, thus takes more power to cut, and might make the drawer thicker than the expected 2 mm play between drawer and cupboard, the user decides to give it a go.

Without making any changes in the user interface, the user continues the process with the new material, i.e., now they measure the 6.5 mm plywood instead and enter its value into the interface, run the cutting power gauge, and box joint gauges and so on, until the system (which we may refer to as “Kalibrator”) eventually laser cuts the drawer.

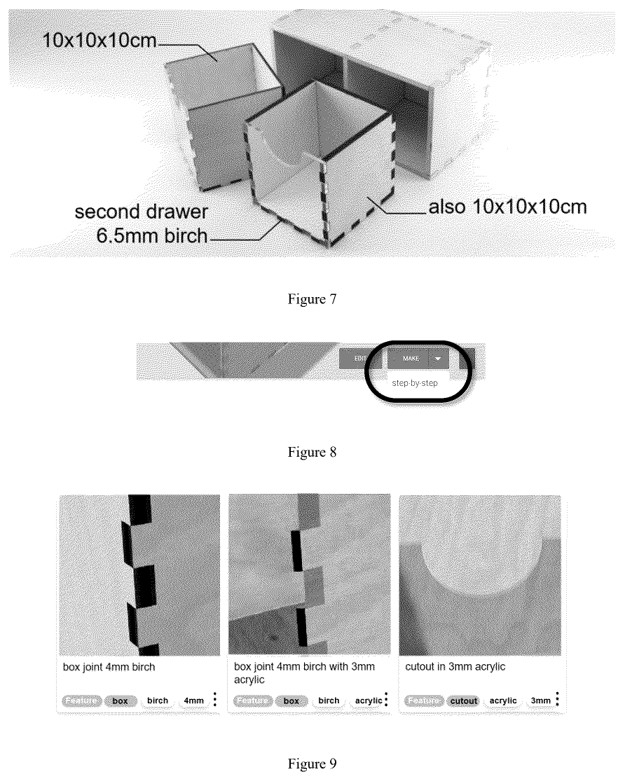

The drawer comes out fine, i.e., as illustrated by FIG. 7, the second drawer is also cut through reliably and without burn marks, and all box joints are again flush and tight. This box also fits into the cupboard. The reason is that Kalibrator adjusted the depth of the joints by 2.5 mm based on new, thicker plywood material.

Some embodiment of the present invention may enable this by modifying the 3D representation of the model, others by encoding the model in a 2D format that allows for this type of changes (such as, LaserSVG, metaSVG, or cutplan, see PCT/US2023/012244).

Thus, while primarily designed to address calibration, the present invention also enables a certain range of last-minute design decisions.

### 6 ALGORITHM

In this section, we explain how the present invention computes a sequence of gauges for a given model, such as the ones shown in FIG. 6. Our algorithm comprises four main steps: (1) feature extraction, (2) mapping features to gauges, (3) gauge dependency expansion, (4) gauge deduplication.

To illustrate the algorithm, we have the user of our example click the secondary option of the “make” button, here labeled “step-by-step” as shown in FIG. 8. This brings the user to a more detailed user interface designed to allow expert users to follow what decisions Kalibrator has made and why, and to finetune the process.

### 6.1 Extracting and Deduplicating Features

Upon clicking “step-by-step”, Kalibrator starts by expanding the model into the subset of elements that may require calibration. We call these “features”. As shown in FIG. 9, the drawer in our example contains two main features that require calibration (box joints between birch and birch, as well as box joints between birch and acrylic); we here also force the inclusion of the cutout in the front as a feature for the sake of illustration.

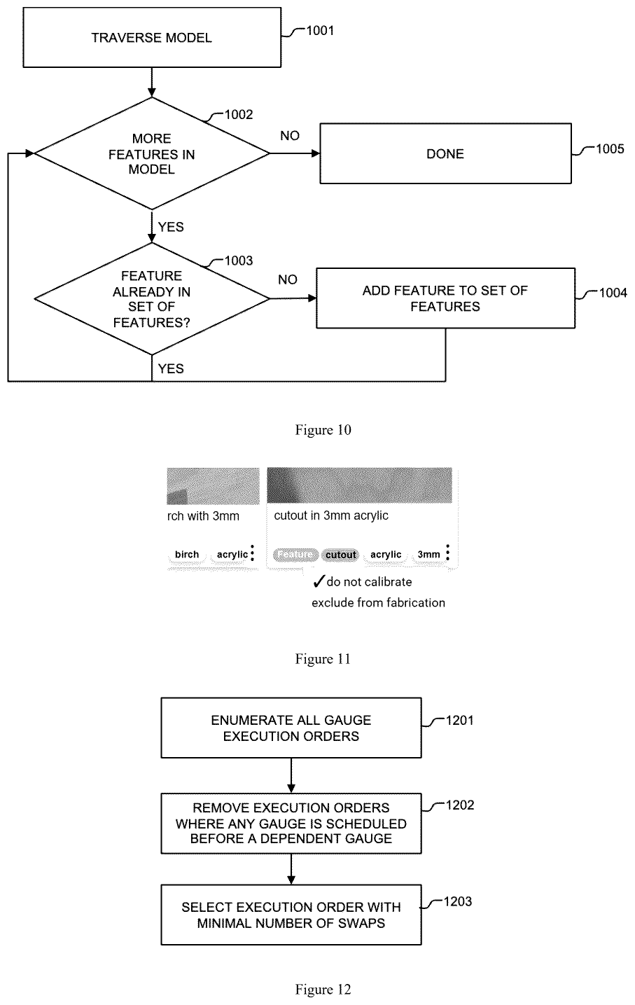

The present invention computes features (Flowchart in FIG. 10) by traversing the model in search of elements that might require calibration, such as joints (box joints, T-joints, cross joints), materials, cutouts, engravings, and markings. When traversing the drawer model from FIG. 2, for example, it identifies the cutout and eight box joints. There “raw” features, however, still contain redundancies: the eight joints fall into only two categories: box joints connecting 4 mm birch with 4 mm birch and box joints connecting 4 mm birch with 3 mm acrylic.

Calibrating each of the redundant features separately would be wasteful. Most Kalibrator embodiments will therefore deduplicate them, e.g., by storing them in a set, so that only the first occurrence of each type is being saved or any other deduplication method.

Note that one of the three features is the cutout in the acrylic front plate—it helps users reach inside in order to pull the drawer out of the cupboard. Kalibrator includes the cutout as a feature, because many types of cutouts do require calibration e.g., cutouts intended to hold an axle. For the drawer, however, the exact size of the cutout is immaterial. We may forego calibration, as shown in FIG. 11, e.g., by picking “do not calibrate” from a “: ” context menu. However, for the time being, we will leave it in—step 4: gauge deduplication will take care of it.

Some embodiments may provide images depicting the features in the user interface, such as the three features in FIG. 9. We have implemented this by screenshotting a virtual camera pointed at the respective feature as follows: It uses the pan and tilt constraints of an ArcballCamera (Ken Shoemake (1992) “ARCBALL: a user interface for specifying three-dimensional orientation using a mouse.” In Proceedings of Graphics Interface '92) until the viewing frustum normal is aligned to the closest vector on the 45° conical frustrum around the normal of the feature. If the stencil buffer shows that the feature is occluded, Kalibrator orbits the virtual camera along the edge of the conical frustrum in small steps (5 degrees) until the feature is not occluded anymore. Other embodiments may use a different approach to obtaining imagery.

Some embodiments may now optimize the order of features so as to minimize the number of times users have to swap materials during calibration.

### 6.2 Mapping Features to Gauges

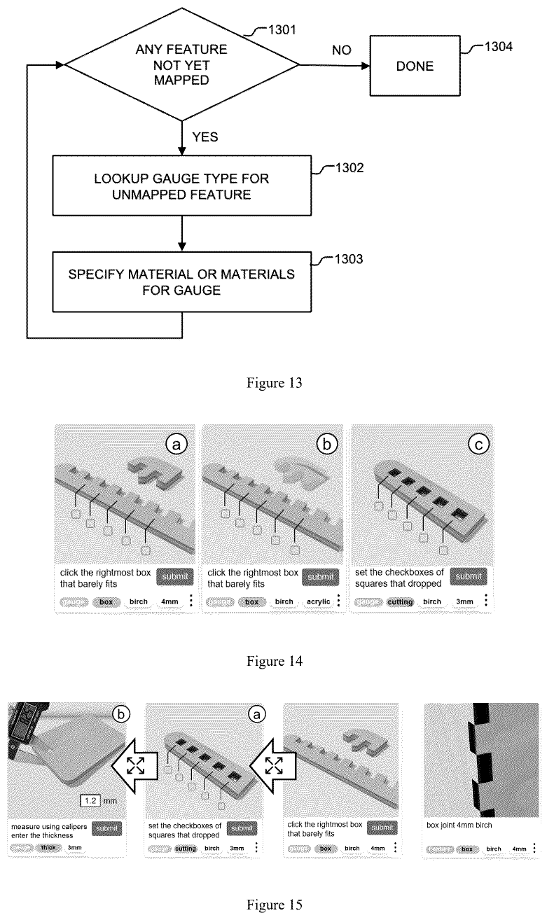

Next (in the shown embodiment this is triggered by the user hitting the “next” button, but could be triggered differently), Kalibrator proceeds by replacing each feature from FIG. 9 with a matching gauge capable of calibrating the respective feature. Some embodiments may maintain an appropriate set of gauges, and a mapping of features to gauges for this purpose, e.g., in the form of a library, a database, or appropriate data structure, resulting in the process depicted in FIG. 13.

The first gauge is a box joint gauge (similar to a kerf strip, which is a bit of a misnomer, in that these devices actually calibrate a combination of kerf and engineering fit). This particular gauge requires users to try to insert the three pins of the shorter part into a series of openings on the longer part—with the openings getting tighter towards the right. The second one is also a box joint gauge, albeit one that tests the particular combination of acrylic and plywood. The last one is a cutting power gauge.

### 6.3 Expanding Gauge Dependencies

If Kalibrator tried to execute the gauges as shown in FIG. 14, it would start by trying to cut the box joint gauge shown on the left—however, it would fail. The reason is that Kalibrator does not quite know how to cut yet. Cutting itself, i.e., how much power to use, is something that requires calibration as well.

Kalibrator addresses this dependency by adding a cutting gauge to the left of the box joint gauge, as illustrated by FIG. 15a (as well as FIG. 3). The cutting gauge attempts to cut holes using different amounts of power. This allows it to determine the least amount of power that is capable of cutting the respective material.

The cutting gauge, however, cannot be executed quite yet either, as cutting requires the laser to focus—and that requires knowing how thick the material is. And while a user may know that a sheet material is supposed to be 4 mm thick, real-world plywood tends to deviate from the specified thickness (not to mention our earlier project of using material of different thickness altogether). It's better to measure. Kalibrator thus expands again, inserting a thickness gauge to the left of the cutting gauge, as illustrated by FIG. 15b.

In this example, there is yet one more dependency: the box joint gauge also specifies a direct dependency to the thickness gauge in order to guarantee correct outer dimensions, i.e., to make the box joints flush (and also to make sure the drawer fits). Formally, the thickness gauge would thus appear twice in the expansion of the box joint gauge. However, to reduce clutter, Kalibrator deduplicates the thickness gauges before displaying them.

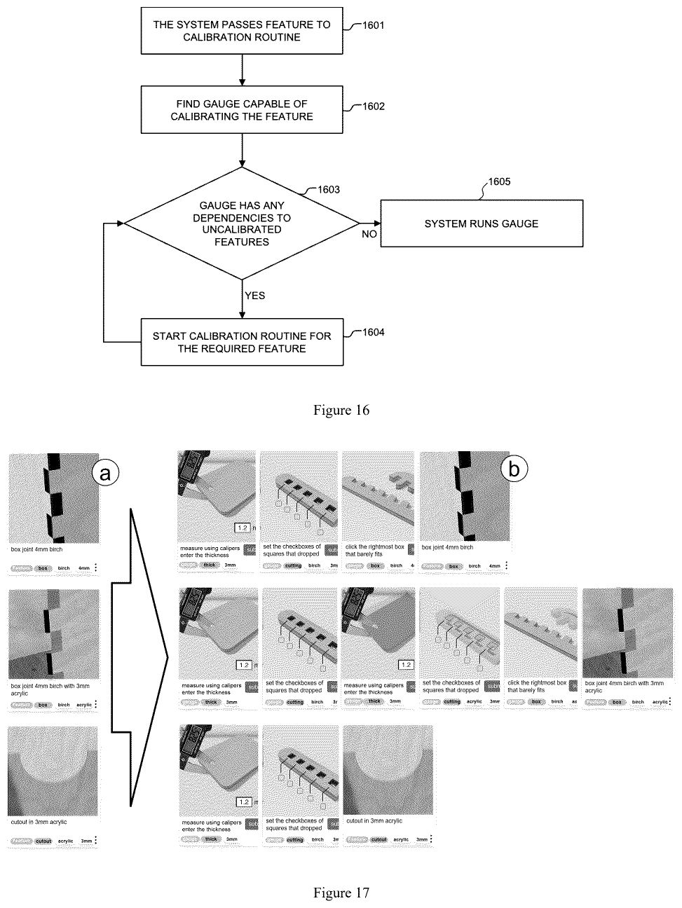

FIG. 16 shows a flowchart depicting how the present invention manages dependencies between gauges.

Some embodiments may show this process, e.g., using the step-by-step user interface shows in FIG. 17, which shows the expansion process of all gauges. (a) To help users follow the process, it first rearranges the three features into a vertical layout, giving each feature its own row. (b) This particular design then expands each gauge by moving it to the right, continuously revealing gauges it depends on, as if spreading a deck of cards.

### 6.4 Deduplicating Redundant Gauges

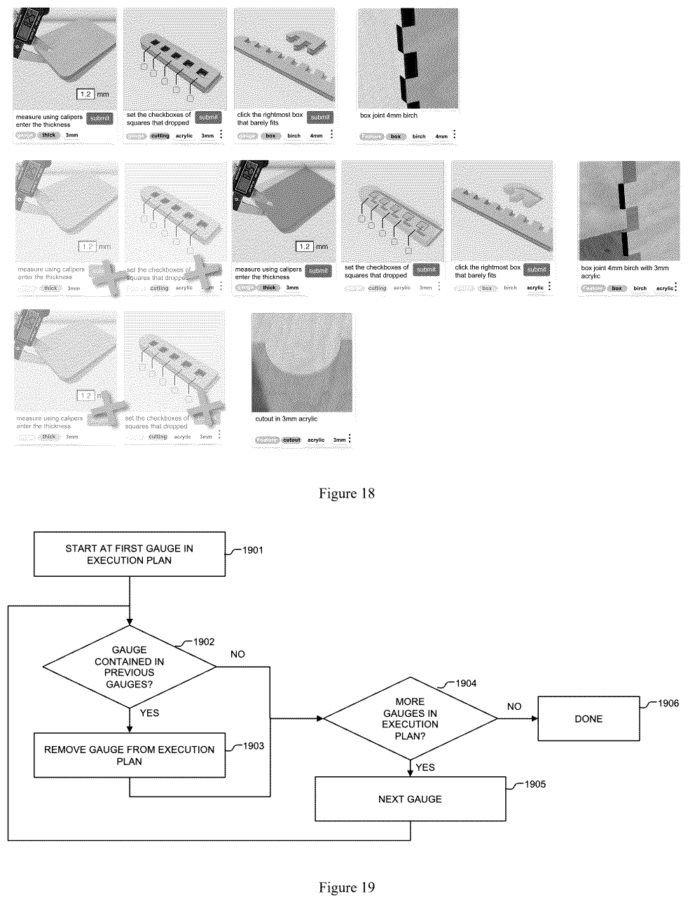

At this point, gauge sets tend to contain redundancies, such as the three birch thickness gauges and three birch cutting power gauges in FIG. 17. Some embodiments may optimize the calibration process by deduplicating gauges. The process illustrated by FIG. 18, for example, keeps only the first instance of each type and deactivates subsequent copies.

The Flowchart shown in FIG. 19 depicts how the present invention deduplicates gauges.

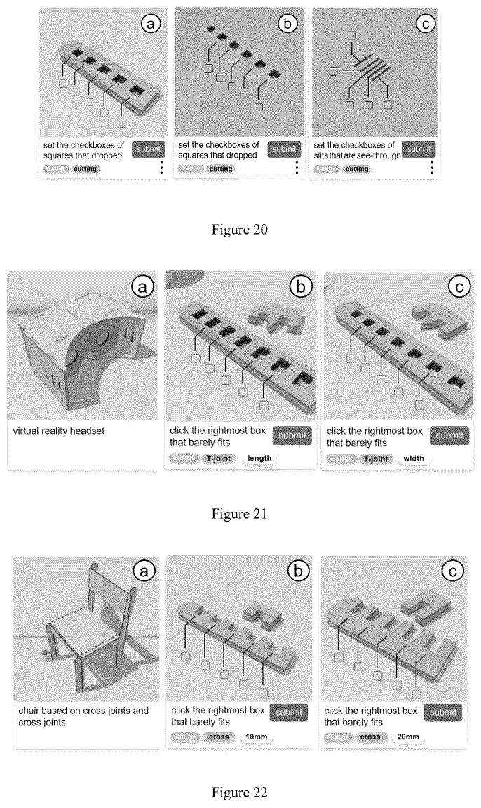

As illustrated by FIG. 20, some embodiments may offer one or more alternative versions for a gauge that are optimized for different purposes. The shown embodiment allows users to access these (here by clicking the “: ” context menu in the bottom right corner), allowing users to swap out (a) the cutting gauge with (b) a fast-to-analyze version that allows users to assess the outcome without opening the laser cutter. The gauge achieves this by aligning cutouts with the laser cutter's grating (see PCT/US2023/012244), making them fall into the grating when cut through. (c) This version is designed to minimize material use, e.g., for costly materials. Nothing is cut out here—instead the user (or a camera) analyzes whether the cut went through, e.g., by checking whether a light can be seen from the other side.

When the user hits “next” one more time, Kalibrator concatenates the gauges into the linear feed shown in FIG. 6.

### 6.5 More Gauges

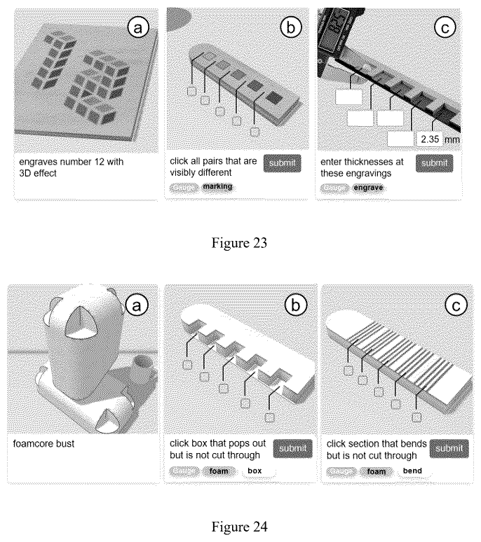

In order to cover a wide range of models, embodiments may offer a wide range of gauges. Here we show gauges for T-Joints (FIG. 21), cross joints (FIG. 22), and engravings (FIG. 23).

Extending Kalibrator to non-standard materials and mechanisms is straightforward. Error! Reference source not found. shows selected gauges for HingeCore (Muhammad Abdullah et al. 2022. HingeCore: Laser-Cut Foamcore for Fast Assembly. In Proceedings of the Symposium on User Interface Software and Technology (UIST '22), 1-13)).

### 6.6 Making Gauges

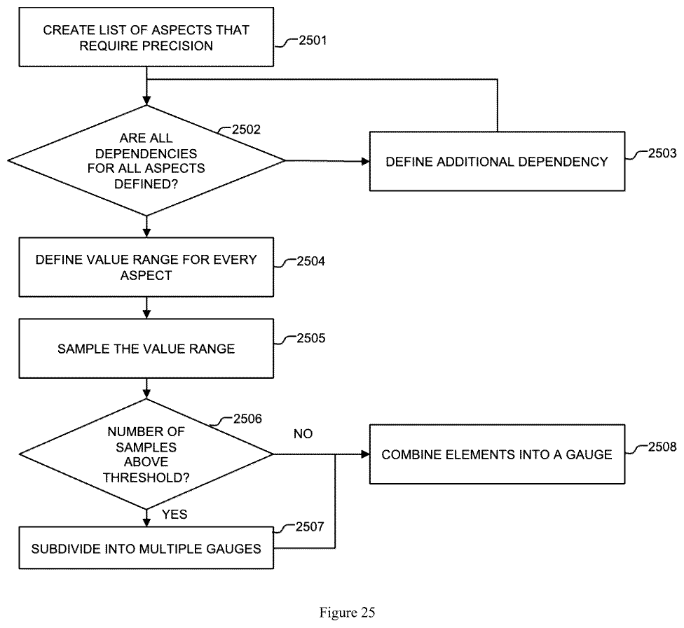

The flowchart in FIG. 25 shows the algorithm for creating gauges for a given feature. (a) create a list of the individual aspects of the feature that require precision and thus calibration. For a T-joint for example, the width and length of the pins as well as the length and width of the slots might require precision in order to obtain a T-joint that is able to take a tension load. (b) Describe dependencies: For each aspect define what other aspects need to be calibrated or measured before the feature itself can be calibrated. For a T-Joint these are for example the material thickness of both materials (depended by length of the pins and the width of the pins respectively) and, like most gauges, they require material to be cut, thus depend on cutting power gauges. (c) For each of the aspects, determine the (ideally smallest possible) range of values that contain the optimum value the gauge is supposed to identify. (d) Determine a function to sample this space, such as linear interpolation, or quadratic, or exponential, etc. (e) Based on the desired precision, determine how many samples are necessary (e.g., range/precision+1). (f) If the number exceeds some threshold, subdivide into multiple gauges. (g) Generate an element for each sample with the interpolated properties, (h) combine these elements into a gauge.

### 7 ADDITIONAL IMPLEMENTATION DETAILS

### 7.1 Feature Extraction

The disclosed system detects and extracts features from 3D models. Some embodiments may provide a dedicated system component for this, loading a 3D model from a standard 3D model file format (e.g., obj, stl, 3mf). Other embodiments providing a feature extraction component may utilize the 2D representation of the 3D model as, for instance, SVG, AI, or DFX file to extract features from. Yet other embodiments may provide this functionality as a plugin for existing editors, such as, but not limited to Fusion360, Kyub, or FlatFab, utilizing internal data structures of these editors to extract features from the represented 3D model.

The feature extraction procedure traverses the 3D model to detect all features relevant for the fabrication process. The order of features detected may or may not be irrelevant. By traversing the edges of the 3D model, features present at the edge, such as box joints or t-joints may be detected. By traversing the surfaces of the model, the feature extraction process may identify features such as t-joints, cross joints, cutouts, markings, or engravings.

### 7.2 Mapping Features to Gauges

The disclosed system passes each detected feature to the calibration routine (FIG. 27, 2701). It then searches the gauge capable of calibrating this feature (FIG. 27, 2702). This search may be resolved by lookup in a data structure defining the mapping of features to gauges or gauges to features, while other embodiments may solve this by each gauge providing which feature it can calibrate or each feature providing which gauge can be used to calibrate it. Some embodiments may support multiple gauges calibrating the same feature, in which case the system may employ any solution to choose one of the gauges, e.g., implementing a decision function based on gauge properties, asking the user etc. Other embodiments may choose to run more than one gauge to calibrate a feature, processing all of their results in some way, e.g., majority voting, taking the mean etc.

The system may be aware of dependencies individual gauges have, e.g., a kerf gauge may require cutting a piece of material, making it dependent on the material thickness and laser power and speed calibration for performing cuts. This knowledge about dependencies may be contained in the system, gauge or even features, depending on the embodiment of the disclosed system. If any of these dependencies exist, and still require calibration (FIG. 27 2703), the calibration routine starts the calibration routine for the feature the current gauge relies on (FIG. 27 2704). This is repeated until all dependencies are calibrated. After this, the gauge is run (FIG. 27 2705).

### 7.3 Sorting and Deduplicating Gauges

Some embodiments of the disclosed system may choose to optimize runtime, material usage, and more by avoiding calibrating features more than once by deduplicating gauges that are executed. This deduplication may be implemented differently by different embodiments of the system. Some embodiments may utilize a registry of singleton pattern [Gamma et. al.] (also known as multiton [O'docherty]) to ensure that the same feature or gauge instance will be reused if it occurs multiple times. Other embodiments may maintain a global data object containing information about previously calibrated features/run gauges.

Some embodiments of the disclosed system may choose to forgo this optimization, either running no deduplication at all, or by performing it at some prior step of the process. This may include immediately deduplicating features as they are detected.

Some embodiments of the system may support calibration for the fabrication of more than one 3D model at one time. These embodiments may choose to perform the deduplication of features or gauges or both for all processed models together. This approach may be implemented to, for example, further reduce the calibration cost in execution time or material use.

### 7.4 Executing Gauges

In this instant invention, we describe the patented system as including gauges that implement their execution as a loop and then applies the result to the calibrated feature. Other embodiments of the system may choose different implementations for the gauge execution method. Not all embodiments may choose to have the gauge directly apply the determined calibration results to the calibrated feature. Other embodiments may also choose to execute a gauge by, for instance, executing a list of functions that are pre-defined and perform all required actions of the gauge, etc.

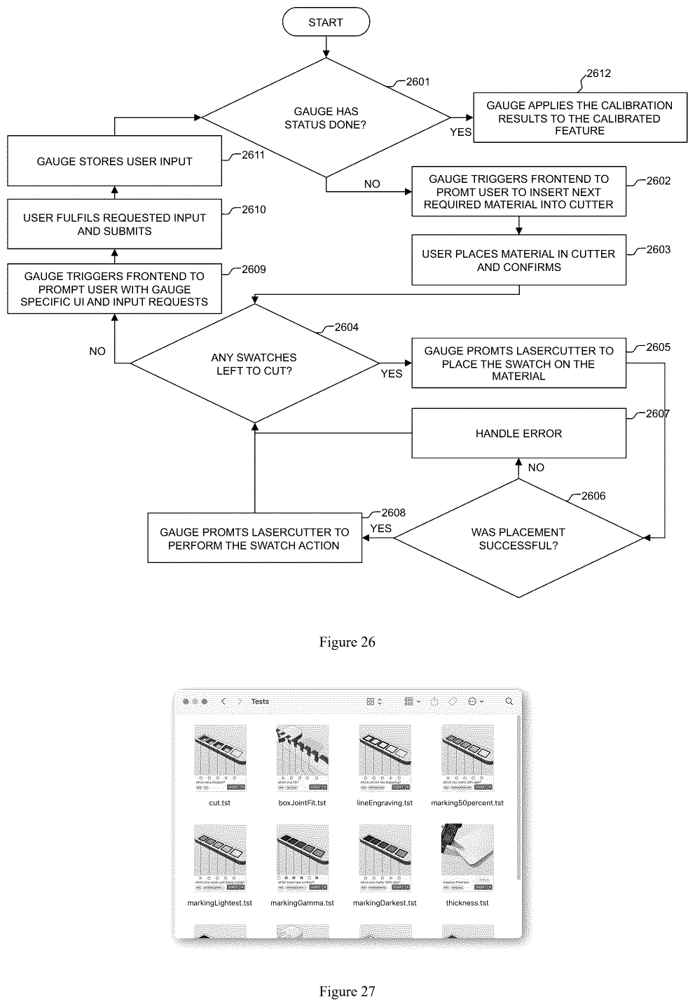

In the presented embodiment of the system, gauges continue their execution loop so long as it does not have a status (or flag, etc.) indicating it has finished all execution steps yet (FIG. 26, 2601). The gauge then triggers a prompt to the user, asking them to insert the next required material into the laser cutter (FIG. 26, 2602). This prompt may be managed by a separate frontend component within the system embodiment, but it may also be controlled directly by the gauge component or some other component within the system. The prompt may be displayed to the user in one of various ways, including but not limited to a popup window, a modal dialog, a text prompt in a text-only environment such as the terminal, or a mobile notification.

Once the user has inserted the next sheet of material into the laser cutter and confirmed that they have taken this action (FIG. 26, 2603), a second loop is triggered in the gauge execution function. As long as there are swatches left to process (FIG. 26, 2604), they will be executed individually. Swatches are individual components of the gauge's full process, which are evaluated to determine the calibrated settings at the end of the gauge execution. Swatches are commonly applied directly to the material (e.g., thickness measurement using a so-called “touch probe”, cutting, engraving, marking) but may also avoid direct interaction with the material (e.g., camera-based detection of material within the laser cutter, or a range sensor, depth camera, or by performing sweep distances or focal ranges with a camera in order focus to identify the distance at which the images is best in focus, which serves as indication for distance).

In some cases, a swatch may require placement (or nesting) on the material in the laser cutter. In these cases, the gauge may perform this placement itself based on prior information such as the material position and outline or it may prompt the laser cutter or any other system component to perform the swatch placement for it (FIG. 26, 2605). If this placement was not successful (FIG. 26, 2606), the system or gauge may choose to handle this error (FIG. 26 2607). The error handling routine may have various implementations, including but not limited to ignoring the swatch, searching and applying an alternative swatch, attempting placement again, prompting the user to resolve the issue, such as by inserting a larger sheet of the same material, etc.

If the swatch placement was successful, the gauge initiates the execution of the swatch. Different embodiments of the system may put responsibility for swatch execution on different actors. In the here presented embodiment, the gauge asks the laser cutter to execute the swatch (FIG. 26, 2608). In other embodiments, the gauge may be capable of controlling the laser cutter and, if present, all sensors within it and does not pass the swatch execution off. Yet different embodiments may have the disclosed system itself or another dedicated component within it execute the swatch.

Once all swatches were processed, the gauge initiates another user-facing prompt. Again, this may be displayed by a dedicated frontend component (FIG. 26, 2609), the gauge, or the system or another system component. This UI may be specific to the gauge or shared between multiple gauges and may include one or more requests for user input (e.g., asking the user to manually use a Kerfstrip and input the determined kerf value). Other embodiments may instead use sensors to determine some or all of the parameters now measured and input by the user.

Once the user has performed all prompted actions and input the requested information, the gauge stores the input (FIG. 26, 2611) as partial or full calibration result. Other embodiments may store this information in a different place than the gauge itself or may immediately utilize the information to run subsequent gauges or modify the 3D model export without storing it any further.

Finally, the embodiment of the gauge presented here applies the calibration results yielded from running swatches and collecting user input to the feature it was called to calibrate for (FIG. 26, 2612). Other embodiments may perform this step at a different time or skip it altogether.

### 8 UNDER THE HOOD: TEST FILES FORMALIZE TESTING

The core of Kalibrator is that it formalizes and abstracts the concept of testing. Kalibrator accomplishes this with the help of a file format we call test. Each test file describes a test exhaustively and independently of any specific laser cutter.

While test files fulfil a crucial function in the kalibrator system, we also think of it as a viable starting point towards formalizing and standardizing the notion of testing—arguably beyond the specific use in kalibrator.

As illustrated by FIG. 27, a kalibrator installation contains a subfolder called “test” that contains a number of test files, recognizable by their file extension .tst. As their thumbnails reveal (here shown in MacOS, but similar on Linux, and Windows), each test file embodies one of the tests that calibration processes are based on.

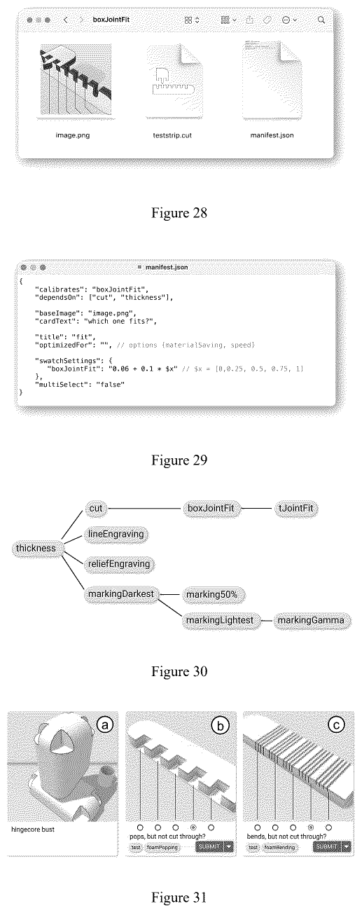

Each test file is a zipped folder, conceptually similar to, for example, a Chrome Extension. To understand how test files work, we rename one of them to .zip and unzip it. As shown in FIG. 28, the unzipped folder contains three files: an image, a manifest, and a test strip.

The image.png should look familiar; it is the main visual element from which the user interface is being constructed (FIG. 3b and FIG. 6). We have also seen the test strip before: it is the 2D model shown in FIG. 3c, albeit in a novel format that gives us the necessary control over cutting power and kerf. We describe .cut in detail in Section “The Cutplan Format”.

Finally, there is the manifest, which is a text file in .json format. Loaded into an arbitrary text editor, we see seven key-value pairs, as shown in FIG. 29.

The seven key-value pairs implement a test in a platform and laser-cutter independent way: The first two key-value pairs handle dependency management: (1) “calibrates”: “boxJoint-Fit” explains that this test calibrates the interference fit for box joints. (2) “dependsOn”: [“cut”, “thickness”] states that before this test can be executed, two other types of tests need to be executed first, i.e., “thickness” and “cut” (see Section “Expanding Dependencies”).

The next two, (3) “baseImage” and (4) “cardText” define the “polaroid-style” user-facing dialog by providing image and text, as shown earlier in FIG. 3b and FIG. 6.

The next (5) “title” helps the user, and (6) “optimizedFor” helps the system pick one of multiple tests designed for the same purpose, such as multiple tests “calibrates”: “boxJointFit”. The shown test one is the generic default and thus has no specific name and is not optimized for anything specific.

(7) Together with the teststrip.cut, the “swatchSettings” defines what will be tested (i.e., boxJointFit). The term “swatch” here refers to one of the five samples to be cut. The shown swatchSettings define that swatches differ in that their boxJointFit will increase linearly between 0.06 and 0.16 as $x takes on the values [0, 0.25, 0.5, 0.75, 1]. (8) Some tests allow multiple swatches to be selected, i.e., if this option is picked, this test will be shown with check boxes instead of radio buttons.

The manifest contains no specific key-value pair to define the return value produced by the test. Instead, tests simply return the swatch the user selected. When the calling function opens the swatch, it finds the settings that produced it, such as “0.11” in case the user had selected the middle swatch, informing kalibrator that offsetting the cutline by 0.11 mm produces the right interference fit for tight box joints.

### 8.1 Loading and Executing Tests

During calibration, kalibrator executes what we call a calibration process, which is a sorted list of tests, such as [“thickness”, “cut”, “boxJointFit”, “lineEngraving”, “markingDarkest”, “marking50percent”] that specifies, for example, the order illustrated in FIG. 6.

In order to execute a test, kalibrator begins by loading the .tst file from its test folder. It then parses the manifest file and to extract the contained key-value pairs (e.g., using Python json).

Kalibrator then generates the user interface by populating instantiating a card (Material UI library for React) (FIG. 6) with baseImage and cardText as parameters.

Kalibrator now creates the actual test strip and prepares it for cutting. For each of the five swatches, kalibrator evaluates the mathematical expressions contained in swatchSettings and applies the resulting settings to the respective swatch in the teststrip.cut. As discussed in detail in Section “The Cutplan Format”, teststrip.cut is a novel file format for laser cutting designed to support this, i.e., to allow assigning different cut settings to different elements.

Kalibrator now sends the updated teststrip.cut to the laser cutter and waits for the user to inspect the result, click the radio button associated with the swatch the user liked best, and hit “submit”.

With the “submit” kalibrator obtains the settings associated with the selected swatch, as mentioned in the previous section. Kalibrator uses these to update its currentEstimateOfLaserCutterSettings. From there, it will be applied to the model and/or the cutter, as well as to all subsequent tests, as we discuss in detail in Section “The Algorithm” below.

This completes the test, and kalibrator proceeds to the next test. When all tests are done, kalibrator fabricates the model.

### 8.2 The Test File Format is Extensible

Kalibrator's collection of 12 test files (eight of which were already shown in FIG. 27) allow calibrating essentially all common laser-cut models.

However, new laser cutting techniques appear from time to time (such as, Foldem: Heterogeneous Object Fabrication via Selective Ablation of Multi-Material Sheets. In Proc. CHI'16, HingeCore: Laser-Cut Foamcore for Fast Assembly in Proceedings of UIST'22, LaCir: A multi-layered laser-cuttable material to co-fabricate circuitry and structural components. In Proc. CHI'24, LASEC: Instant Fabrication of Stretchable Circuits Using a Laser Cutter. In Proc. CHI'19). Kalibrator, therefore, allows users to extend its test collection by creating and uploading matching tests.

In Error! Reference source not found., for example, a user is planning to fabricate a model made from HingeCore a fabrication technique that requires cutting the 3-layer sandwich material foamcore to different depths. To assure perfect calibration, the user designs (b) a test that determines the power required to cut through the top two layers and (c) a test that determines the power required score the material to produce this specific variety of living hinges.

The most efficient way to do so (very much in analogy to writing a chrome extensions) tends to be to locate a test that is structurally similar. The reliefEngraving test has a test strip that looks about right for the first example; the second we create from scratch.

Users then update the manifest by replacing “reliefEngraving” with “hingecore:cutTwoLayers”, the card text to “pops but not cut through?” and change the swatch settings formula for cutting speed to “100%*(1%/100%)^{∧}$x”. The dependencies now also include “cut”. Users may keep the existing image.png or create a new one (as we did for Error! Reference source not found.b and c). Users then rezip the test, give the resulting test file an appropriate name, such as foamcoreCutTwolayers.tst, and store it in the test folder (FIG. 27).

In the future, one would expect tests to be shared via an online repository.

### 9 THE ALGORITHM THAT RUNS TESTS

To allow readers to create their own implementation of kalibrator, we now explain the architecture we built around the test file format, i.e., the other data structures and algorithms.

### 9.1 Step 1: Loading a Model and Extracting its Features

Conceptually, kalibrator could run a generic calibration process that runs all common tests. However, running such a generic test would consume more time and material than necessary. In order to minimize calibration time, kalibrator creates a custom calibration process that contains only those tests that are actually required by the model at hand.

To determine that set, kalibrator searches the model sent to it for elements that require calibration, such as box joints, engraving, etc. We call these features and there is a strong and intentional correspondence between features and test.

Since SVG is the most common format for encoding laser-cut models in the community (Wikipedia), we designed kalibrator to accept SVG for input. This comes with its challenges, as SVG lacks semantic information. For example, SVG does not distinguish between plates and scrap; it does not contain any information on material thickness; all line-based features such as cutouts, box joints, and line engraving all look the same, and so on.

Kalibrator therefore reconstructs the missing semantic information, in particular kerf, material thickness, and line styles:

In order to allow kalibrator to correct kerf (by dilating or eroding parts), (1) Kalibrator reconstructs which surfaces in the SVG are parts. Building on Assembler³ (assembler3: 3D Reconstruction of Laser-Cut Models in Proceedings of CHI'21), it labels the material inside the outermost polygon of the SVG as part, then, moving inwards, alternatingly as scrap and part. (2) Then kalibrator determines the kerf in the SVG at hand. Again, building on Assembler³, kalibrator performs plate detection, joint detection, and joint matching.

However, kalibrator deviates from the related work in that it does not try to pair joints up, a process known to be error-prone (only 79%, not acceptable for kalibrator). Instead, kalibrator pairs up matched joints randomly, which is sufficient for determining the overlap/interference between the paired-up joints. It then determines the SVG's combined kerf and fit as of half median of all interferences.

In order to allow kalibrator to adjust models for actual material thickness, kalibrator guesses the material thickness of SVGs by generating a histogram of common line segments length and picks the most popular value from it. Kalibrator also marks line segments of that length for later material thickness correction.

To tell cutouts, joints, and line engravings apart, kalibrator employs the following six heuristics: (1) non-closed polygons are likely line engravings. (2) The outmost closed polygon is a cut. (3) Cut lines following certain patterns (such as left, left, right, right) are joints. (4) If one color is cutting, then the other color tends to be engraving. (5) Filled polygons tend to be engravings (6) where the fill color is likely to express the darkness of the desired engraving.

Once kalibrator has reconstructed the semantic information of the SVG, it extracts features, i.e., it traverses the model in a single pass in which it creates a record of the features it encounters, such as boxJoint, lineEngraving, engravingDarkest, etc. stores them in the features set data structure.

### 9.2 Step 2: Mapping Features to Tests

Now kalibrator creates a first version of a calibration process by simply mapping features to tests, i.e., for each feature kalibrator picks one matching test from its library. In order to calibrate the feature engraving, for example, it looks for a test containing “calibrates”: “engraving”. Kalibrator thereby defines the initial version of the calibration process.

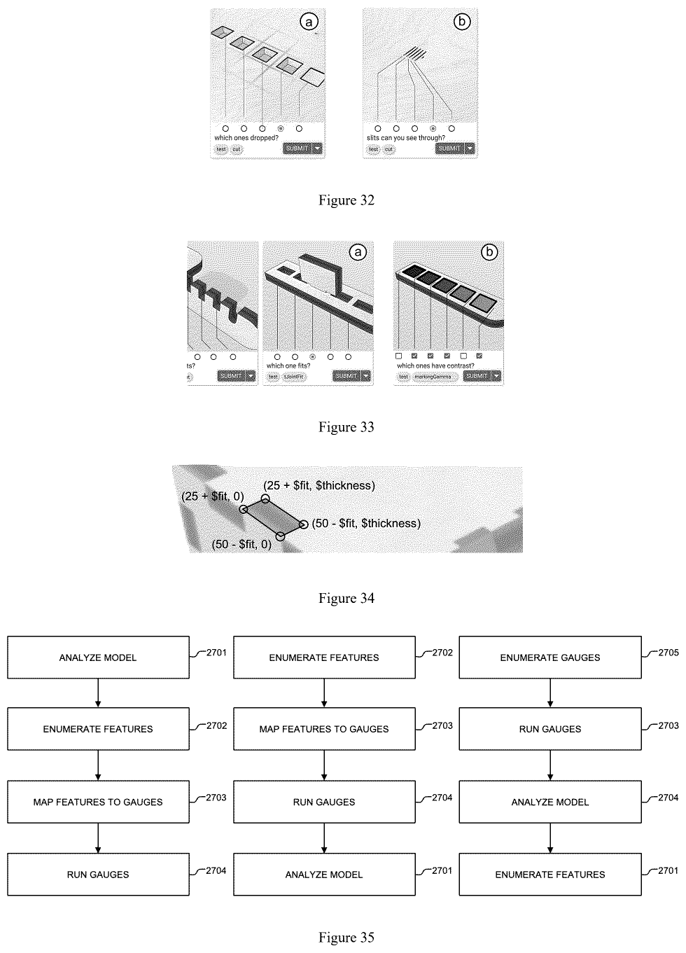

As illustrated by FIG. 32, kalibrator may offer multiple tests with the same purpose, but optimized for different purposes, such as (a) for speed (users can assess this strip without opening the laser cutter, as its cutouts align with the laser cutter's grating, making fully cut squares visibly fall through the grating) or (b) to minimize material use (these cuts are very small). As shown in FIG. 29, test creators express this by assigning an appropriate value to “optimizedFor”.

Kalibrator allows users to pick a global strategy for picking tests by setting a dropdown “optimize for” at the start of a calibration process or to swap out tests at runtime by clicking the ∨ menu next to test's submit button.

Finally, some features map to multiple tests. As shown in FIG. 21, for example, kalibrator maps T-joints (a) to a boxJointFit test, followed by a tJointFit test, i.e., the boxJointFit test calibrates the lateral fit, that box joints and T-joints have in common. The tJointFit test then only needs to calibrate the vertical fit, which is unique to T-joints.

The expansion of a feature into multiple gauges is an essential feature of kalibrator's that allows for fast calibration. Where traditional test strips tend to spell out the cross product of multiple parameters, resulting in a 2D array of swatches (e.g., material test generator in LightBurn https://lightburnsoftware.com) kalibrator, capable of proceeding from test to test quickly—allowing it to factorize tests, i.e., instead running sequences of multiple shorter tests. This allows kalibrator to reduce time and material consumption from n² to 2n for two parameters or (b) from n³ to 3n when calibrating the engraving gamma for photo engraving, by first running an marking darkness test that searches over DPI and focus offset simultaneously and then an engraving-Gamma test.

### 9.3 Step 3: Expanding Dependencies and De-duplication

Most tests depend on other tests, as we already alluded to when discussing the test manifest (FIG. 29). The fit test in this example, states “dependsOn”: [“cut”, “thickness”].

Kalibrator resolves this dependency by inserting a cut test into the calibration process, right before the fit test. Kalibrator then inspects the cut test and finds that it depends on thickness, thus also inserts a thickness test into the calibration process, right before the cut test.

The resolution of dependencies may introduce the same test multiple times: box joints, T-joints, and cutouts, for example, will always introduce a cutting test. Kalibrator, therefore, deduplicates the generated calibration process: it keeps only the first instance of each test, discarding the others. This produces an order in which dependencies are preserved and executed in a valid order.

### 9.4 Step 4: Loading and Running Tests, Nesting

Kalibrator now executes the calibration process as already presented in Section “Loading and Executing Tests”. As part of this execution, kalibrator cuts the test strips, which kalibrator nests onto the model's material sheet (using packaide https://github.com/DanielLiamAnderson/Packaide), which generally works out, given that kalibrator test strips are reasonably small.

Since Kalibrator requires users to open the laser cutter during calibration in order to retrieve the test strips, we tend to use a camera to re-register the model with the material in the cutter. Many modern laser cutters offer such a camera, if not, we integrate a Sony IMX287, the image of which we segment in OpenCV (https://opencv.org) (cv2.remap, cv2.threshold, cv2.connectedComponents).

### 9.5 Step 5: Kalibrator Controls the Laser Cutter

In order to cut the test strips, kalibrator needs to control the laser cutters, i.e., not just to send it the test strip model, but also to feed it the swatch settings specified in the manifest.

Kalibrator generally does so by talking to the laser cutter manufacturer's proprietary control software. Kalibrator talks to these using UDP calls (e.g., Lightburn), HTTP calls (e.g., Trotec Ruby), or system calls to the printer driver interface (e.g., Universal Laser Systems' Control Panel).

Kalibrator allows users to add their specific laser cutter, by implementing a single 150-line python class we call LaserCutter, that contains all cutter-specific code in one place. Users instantiate LaserCutter and fill in the four methods it contains, i.e., moveLaserHead( ) and moveTableUpDown( ), isLidOpen( ), and cut( ), the latter taking a list of geometries and the currentEstimateOfLaserCutterSettings as parameters. The task of the four methods is to control the laser cutter using the protocol listed above.

To produce an even faster and more responsive user experience, we found it useful at times to bypass the manufacturer's proprietary control software by reverse-engineering the manufacturers protocol and controlling the cutter directly.

### 9.6 Step 6: Adjusting the Model

As discussed earlier, kalibrator classifies features upon loading input files, such as SVG. Kalibrator now uses the result of this classification to adjust the model.

To keep the model amendable, kalibrator stores the imported 3D model in the data structure shown in FIG. 34, which we will refer to as cutplan. This data structure represents models in 2D format, with its main entities being plates. This data structure also forms the basis of a new semantic exchange format for laser cut models, which we already alluded to when discussing teststrip.cut. this new file format is another one of the main contributions of this paper.

As shown in FIG. 34, the cutplan data structure builds on LaserSVG (https://github.com/florianheller/lasersvg) in that it encodes the coordinates of joints as arithmetic expressions. However, unlike LaserSVG, it represents joints as a number of rectangles that are being either subtracted from plates (represented as polygons).

This not only overcomes the shortcomings discussed in the “Related Work” section, but also allows kalibrator to correct for kerf easily, i.e., by changing the width of the rectangle, which the code snippet shown inline below can do by adjusting the value of the global variable $boxJointFit. Similarly, once the material thickness has been measured, the cutplan data structure allows adjusting material thickness by adjusting $thickness. Adopting the syntax of both SVG and LaserSVG, cutplan expresses the rectangular slot to be subtracted from a plate as:

$$< polgon points {=}^{‶} \{ 25 + \$ boxJointFit \} , 0 \{ 25 + \$ boxJoint - Fit \} , \{ \$ thickness \} \{ 50 - \$ boxJointFit \} , \{ \$ thickness \} \{ 50 - \$ boxJointFit \} , {0}^{″} > .$$

As discussed above, the key value of cutplan lies in the fact that it allows storing semantic information. Cutplan accomplishes this by storing in each plate (in addition to its geometry) engravings etc. with semantic attributes, such as “cut” or “mark”. Cutplan uses the same types as test, i.e., the keyword “cut” here makes direct reference “calibrates”: “cut” in a test file.

Once the model is adjusted by all steps in the calibration process, kalibrator's currentEstimateOfLaserCutterSettings represents a set of settings that allow cutting the model at hand at high quality. Kalibrator loads its settings into the laser cutter using the sends the model to the laser cutter via the LaserCutter interface and adjusts the model using cutplan. Kalibrator then sends the model to the laser cutter for fabrication.

### 9.7 The Cutplan Format Allows High-Quality Laser Cutting

While working on kalibrator, it became clear that the cutplan data structure is useful not only for implementing teststrip.cut and to adjust the model as calibration progresses, but it also makes for an excellent way to store and exchange laser cut models: Since cutplan preserves the complete semantic information associated with the model, it allows communicating the design intent behind the model, which is a clear necessity when we want to fabricate models at high fabrication quality.

We therefore went a step further and turned cutplan into a file format by serializing and exporting the cutplan data structure in the form of an XML-based file format and by writing corresponding file loaders. We use the extension.cut, as already mentioned when we discussed teststrip.cut. See supplementary materials for an example file. We will open-source the cutplan encoder and decoder upon acceptance.

To validate our design, we provided kalibrator with cutplan import and added cutplan exporters to two laser cutting design programs (kyub kyub.com and FlatFitFab flatFab.com). When sending 3D models from these design tools to a cutplan-enabled laser cutter (e.g., via kalibrator), all features are encoded by these 3D editors, i.e., where all features are still fully available, as these tools, of course, know, that something is a box joint and that something else is a relief engraving.

Since the semantic information never gets lost in the first place, this eliminates the necessity to restore the semantic information as discussed in Section “Loading a Model”; the semantic information is simply encoded in the cutplan file, making the exchange simple and reliable, therefore forming a basis laser cutting at high quality.

The kalibrator export plugin for FlatFitFab traverses FlatFitFab's internal representation of 3D models, which is a set of plates positioned in 3D space, with cross joints implicitly defined by intersections between these plates in 3D-space. Each plate is defined by the data structure PlanarSection, which describes its outline in 2D space. As the cutplan exporter traverses a plate, it writes a cutplan </polygon>representing the outline of the PlanarSection. Then it writes additional rectangles for the slots (PlanarSection::getSlots) and adds the tag </difference>to express that these are to be subtracted.

The kalibrator export plugin for kyub also traverses the structure of all plates. Unlike FlatFitFab, Kyub represents 3D laser-cut models as a half-edge-mesh. The export plugin iterates over all plates, i.e., the faces of the half-edge-mesh, and writes their outline. It then writes cut-outs, markings, engravings, which are stored as properties of the mesh-face in kyub. Finally, the plugin iterates over all of the edges of all plates and subtracts rectangles from the outline for every box joint slot that it finds.

### 9.8 Tuning the System for Speed

While Kalibrator primarily targets non-experts, we still intend it to be relevant to expert users. Since these users are capable of performing their own calibration, we have explored several ways of optimizing the speed of the invention disclosed in this document, so as to be competitive based on speed alone. In order to achieve this, we performed the following optimizations:

(1) We have automated the nesting of gauges onto the material by integrating a camera (IMX179 sensor) and operating it using OpenCV (https://opencv.org) and a modified version of packaide (https://github.com/DanielLiamAnderson/Packaide) (extended to have a REST interface that accepts polygonal data instead of the original SVG-based interface). (2) We minimized the number of times users have to swap materials, by making Kalibrator sort gauges by material without breaking dependencies. (3) We minimized the number of times users have to open the cutter by designing cutting gauges readable from the outside (FIG. 20). (4) We eliminated wait times introduced by the Trotec ecosystem (Trotec Job Control, https://www.troteclaser.com/en/laser-machines/jobcontrol) (˜7 seconds per cut job) by reverse engineering their serial protocol and sending fine-grained, GCODE-like instructions to move the table, the gantry, and cut individual line segments at interactive rates.

With these optimizations in place, experienced users can perform the calibration sequence shown in FIG. 6 in about 8 minutes.

### 10 ALTERNATIVE EMBODIMENTS

### 10.1 Alternative Order of Calibration Process

Earlier in this document, we described how systems embodying the present invention select gauges using a 4-step process: (1) feature extraction, (2) mapping features to gauges, (3) gauge dependency expansion, and (4) gauge deduplication.

Other embodiments may perform only a subset of these steps (see selected Flowcharts in FIG. 35). For example, some embodiments may leave out step 1 “feature extraction” and instead, for example, assume a default set of features. Other embodiments may leave out step 2 “mapping features to gauges” and instead consider features and gauges to be the same. Other embodiments may essentially swap steps 2 and 3 by defining the expansion rules on features instead of gauges. Other embodiments may leave out step 3 and instead map directly to sets of gauges instead. Yet other embodiments may leave out step 4 “deduplication” and either run gauges repeatedly or deduplicate implicitly as part of one of the earlier steps.

While in the disclosure above, the described system starts with a single model and then derives gauges from that, other embodiments may allow starting with a set of models instead and generate gauges for the entire set.

Yet other embodiments may run in the absence of any specific model and instead calibrate preemptively, i.e., as preparation for models to arrive in the future. Such a preemptive calibration may be performed on materials expected to be used in the future and defined by a set of features expected in future models, and then continue (2) mapping features to gauges, (3) gauge dependency expansion, and (4) gauge deduplication, or it may be defined in terms of gauges, starting with step 3 or it may even skip all four steps and run a canned sequence of gauges (e.g., run a premeditated standard set of gauges and then only when fabricating a model pick the relevant ones for the model at hand.)

### 10.2 Cutting 2D Models, 3D Model Defined Elsewhere, & Engraving Objects

While we referred to 3D models assembled from multiple parts with the help of joints, some embodiments may process 3D models that do not have explicit joints, such as plates to be laminated/glued together as is (e.g., stacks, butt joints, etc.).

Alternatively, they may not be 3D at all—but a simple 2D model. Such models may still be encoded in a 3D format or may be encoded in a simpler 2D format, such as SVG, OBJ, Adobe Illustrator, DXF, PDF. The process described above applies just the same, i.e., such as extract features and generate, expand, and deduplicate gauges for them; the only difference is that they will generally not produce gauges for joints, as these are not part of the model.

While the examples shown so far assumed models to be made from scratch, alternatively users may use the fabrication machine to process partially or fully formed objects, such as plates or bottles or laser-cut or milled 2D or 3D models, etc. The process described above still applies, except that no cutting gauges may have to be generated. Instead, only engraving gauges (such as marking gauges and/or relief gauges) may be generated; these may still depend on thickness gauges, etc.

While the examples shown so far assumed 3D models to be defined in a 3D format capable of performing the described operations, some embodiments may allow loading foreign formats, such as AutoCAD, Fusion 360, Onshape, OpenSCAD, Obj, STL, 3MF, and so on. In this case, some embodiments may convert the imported file to the format capable of performing the described operations (and back).

### 10.3 Calibration for Models Available in 2D Data Formats

So far, we have assumed that the model itself be present in a form that allows features to be extracted and changes to be applied—we typically assumed 3D models to be defined in a 3D format. This may not always be the case, as a model may only be available in a 2D format, such as SVG, Adobe Illustrator Artwork, PDF, AutoCAD DXF, SWF, Windows Metafile, etc. Accordingly, some embodiments may allow loading 3D models encoded in the form of parts in a 2D format.

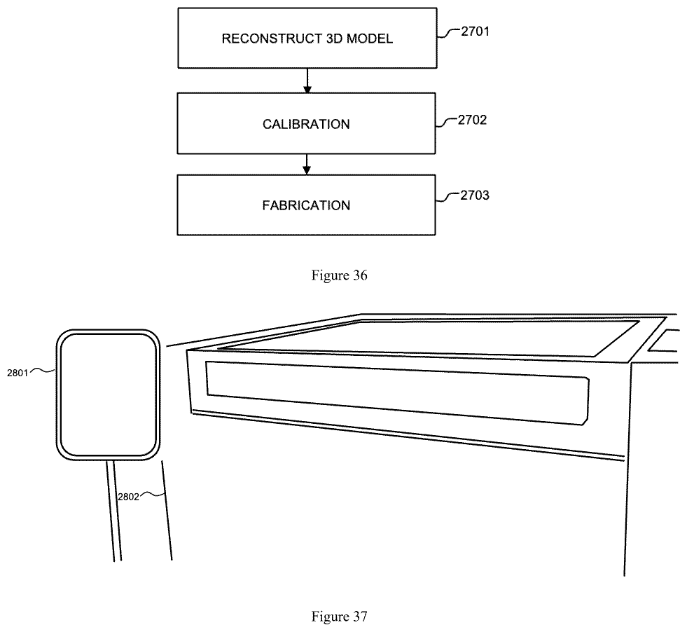

The flowchart shown in FIG. 36 shows (a particularly compact) approach to applying calibration to such 2D representations, which is to (1) re-assemble the 3D model from the 2D representation either manually, semi-automatically (assembler³, Thijs Roumen et al. 2021. Assembler3: 3D Reconstruction of Laser-Cut Models. In Proceedings of the 2021 CHI Conference on Human Factors in Computing Systems (CHI '21). Association for Computing Machinery, New York, NY, USA, Article 672, 1-11) or automatically (autoAssembler, Thijs Roumen, et al. 2021. AutoAssembler: Automatic Reconstruction of Laser-Cut 3D Models. In Proceedings of the Symposium on User Interface Software and Technology (UIST '21). Association for Computing Machinery, New York, NY, USA, 652-662). (2) The calibration process then continues as before and in particular allows for export of a relevant format (LaserSVG, metaSVG, cutplan etc.) and thus application of the necessary adjustments to the model.

In a different embodiment, the 2D representation is converted into a parametric 2D format, such as the cutplan format described in PCT/US2023/012244. By using the calibrated values into the evaluation

Alternatively, some embodiments may choose to parse the model file without delegating to assembler³ or autoAssembler and instead apply only selected steps out of these 3D reconstruction processes, in particular the detection and extraction of the relevant features, such as box joints, material thickness, classification of parts vs. left-over material, etc. Such a more “pedestrian” approach is relevant, because the requirement for calibration can be lowered compared to a full 3D reconstruction: for full 3D reconstruction, joints have to be paired up unambiguously, while for many types of calibration some ambiguity may be allowed to remain (some n joints fitting some other n joints), as this is sufficient to adjust, for example, kerf. (It is sufficient to match a set of n joints to a set of n other joints, so as to determine the kerf the model assumes what kerf this model has been designed for, i.e., the overlap or interference between the two halves that make up a joint). Also, the angle at which two parts with be joined some embodiments may consider expendable. These observations lower the requirements to the detection of material thickness, classification of parts vs. left-over material, and location of joints and then reconstructing a graph of the parts instead of an actual 3D model. This increases the success rate compared to actual automatic 3D construction.

The respective embodiment may apply changes that affect the fabrication device as discussed earlier. Cutting power settings may either be send to the cutter separately from the model, be included in the model, or be intermediately stored and later retrieved.

It may apply changes to the geometry, e.g., in response to calibrating kerf, by detecting sections of the 2D model that resemble a joint (box joints, t-joints, cross-joints, etc.), mount or other thickness-dependent part by using the methods presented in the assembler3 paper mentioned above, then modify these parts by moving and scaling the edges surrounding joints in or out—or, for simplify, just erode and dilate all parts.

### 10.4 Alternative User Interaction Methods and User Interface Devices

Different embodiments (especially of semi-automated calibration systems) may offer a user interface to users. They may do so on one or more device, such as mobile devices, tablets, laptops, personal computers, via the web or other service, etc. These devices may be users' personal devices, shared devices, public devices, or devices that belong to the cutter. The devices may be connected to the cutter directly, via a network, internet, serial connection. FIG. 37 shows one such configuration that uses a tablet connected to a server by wireless network.

While in the disclosure above, users operate the system by means of a user interface generated for display by a web browser, other embodiments may pick a different platform (native, service . . . ) and modality (video, audio, haptic, etc.).

While in the disclosure above, the user interface is displayed on a dedicated device, other embodiments may display a user interface instead (1) using a dedicated application running on a separate device. (b) A different general-purpose application running on a separate device (email client, messenger application, or similar) (3) A screen integrated into the laser cutter. (4) Audio cues, including the use of Speech output. (5) Projecting onto the material. (6) Printing Instructions onto paper or some other suitable material. (7) Augmented Reality Headset, (8) Haptic cues, including the use of vibro-tactile, (9) Any other display technique. Yet other embodiments, especially fully automated ones, may display no information to the user.

Or use other input methods, including, but not limited to touch screens, mouse, trackpad, keyboard, buttons, joystick, on any other of such traditional human input devices, on a separate device or the laser cutter, Speech input, Tracking the user, hands, gaze, etc.

### 10.5 Alternative Fabrication Methods

While in the disclosure above, the described system is controlling the fabrication process of a laser cutter based on a gantry system, other embodiments instead control laser cutters based on galvanic mirrors, or laser cutters that use one of more diode lasers, etc.

Yet other embodiments may instead control different types of fabrication machines, such as but not limited to the devices described in PCT/US2023/012244, such as CNC milling machines, waterjet cutters, plasma cutters, any other subtractive fabrication machine.

Most of the process described in this disclosure also applies to additive fabrication methods, such as fused deposit modelling 3D printers, powder bed fusion 3D printers, vat photopolymerization 3D printers, CLIP, computer controlled knitting machines, any other additive fabrication machines.

### 10.6 Automatic Gauges/Automatic System

So far, we presented Kalibrator as a system that semi-automates the calibration process, thereby allowing non-expert users to obtain high-quality results from laser cutters by managing the calibration process for them. Some embodiments, however, may automate the calibration process further.

While in the disclosure above, the described system relies on instructing users to evaluate the gauges, automated embodiments will evaluate gauges using fully automated sensors, e.g., including, but not limited to sensors such as cameras, 3D cameras & depth cameras (Lidar, structured light, time of flight, etc.), touch probes, or any of the sensors and methods described in PCT/US2023/012244. These may be integrated into the laser cutter and then process the sensor readings, e.g., camera output using computer vision code.

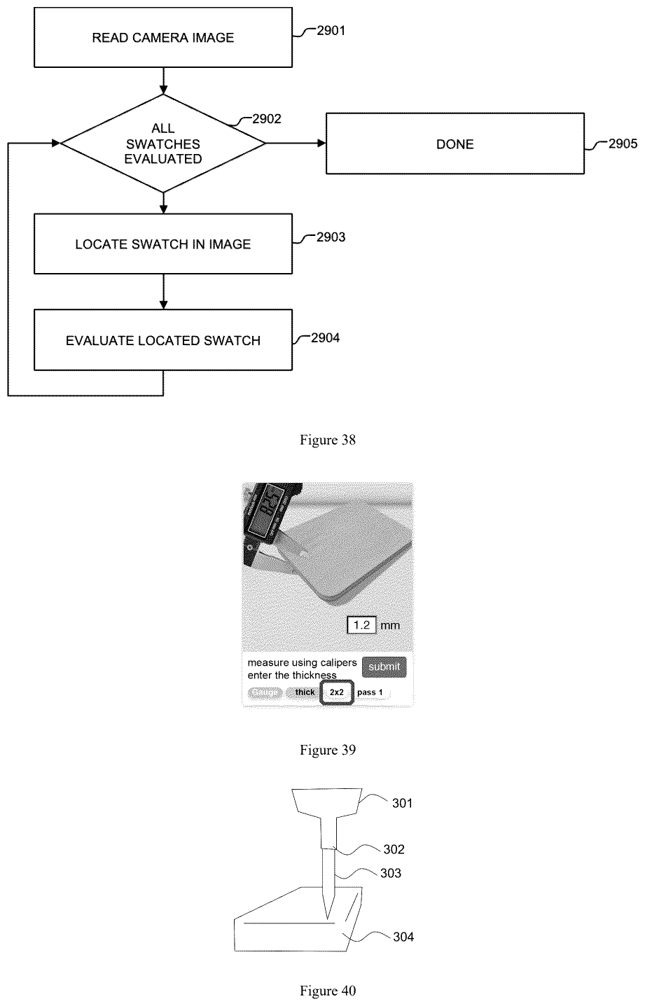

The flowchart in FIG. 38 illustrates the general process at the example of how to automatically process a gauge based on reading a camera image. As someone skilled in the art would appreciate, 403 locating a swatch (aka element) can be done by basic computer vision techniques, such as those used for image segmentation. Alternatively, gauges may be extended with registration information, as common in markers, such as QR codes, etc.

Sensors may be also integrated into a different device (e.g., a mobile phone), a different user (or multiple) performing the calibration routine that is present at the fabrication machine, a different user (or multiple) looking at sensor values (e.g., a camera image) that is not present at the fabrication machine, a combination of the above. Some embodiments will also use actuators, e.g., integrated into the fabrication device, e.g., to actuate gauges.

The material thickness gauge may be automated by using a touch probe, as discussed in PCT/US2023/012244. The cutting power gauge may be automated by reading it using a camera, e.g., when cut over a hole on the grating inside the laser cutter (as described in PCT/US2023/012244), so that the camera only has to tell whether the respective cutout has dropped into the grating. Box joint gauges may be automated in the form of a Kerfmeter (as described in PCT/US2023/012244).

Mixed-material box joint gauges can be automated by providing actuators that (robotic arms in the general sense or simplified versions thereof), or approximated by measuring kerf for the two involved materials separately and then aggregating their results, by testing only the softer of the two materials probed with a probe that is part of the system, etc.

Cross-joint gauges may be automated with the help of a robotic arms in the general sense or simplified versions thereof. Gauges representing the width aspect of T-joints may be automated by representing them as box joints or simply declaring a dependency on a box joint gauge. Gauges representing the thickness of T-joints may be automated by representing them as cross joints or simply declaring a dependency on a cross joint gauge. Engraving “relief” gauges may be automated by measuring the resulting depth using a touch probe.

An embodiment may use semi-automatic gauges (i.e., users help) and/or automated gauges or any combination of the two. If all gauges are automated, then the system may run the entire process without user interaction (except insertion of material, unless that is automated as well with a conveyor belt etc.). However, some embodiment may implement a fully automatic system combined with a semi-automatic system as failsafe/fallback when a sensor fails or when the sensor for a specific (unexpected) gauge is not part of the system yet (e.g., in a modular system where users buy sensors when they need them).

### 10.7 Multiple Sheets of Material

While the disclosure above describes a process where only a single sheet of material is located in the cutter at a time, other embodiments may allow multiple sheets to be placed into the cutter at the same time. This may be multiple truly interchangeable sheets, i.e., of the same material and with the same properties, so that it is sufficient to perform each gauge only once and then for that matter on any of the sheets. In this case, the embodiment may simply employ a multi-sheet nesting program to nest both gauges and model.

The materials may be interchangeable in terms of the user being ok with any part of the model being made from either of the sheets—while the sheets are different in that they may require individual calibration. In this case, the system may run calibration for each sheet separately and then nest on the whole.

Finally, the sheets may not be interchangeable, e.g., as part of a model the parts of which require different material properties, such as a drawer with a clear front. Again, the system would run calibration independently for each sheet. Before nesting, however, the system has to decide which parts of the model to map on which sheet. It accomplishes this with the help of a program that matching materials to the model to as to minimize deviation from the material properties defined in the model (see material mapping in PCT/US2023/012244).

### 10.8 Feedback About Machine State, Progress Display, Recovery of Operation

Some embodiments may provide feedback to the user about what the device is doing, what state it is in, whether it requires user input, and how much time is remaining—this is especially useful as part of semi-automated calibration (as users will need to wait for a multiple cutting operations to take time), but also independent of that, e.g., during automated calibration or even independent of calibration, i.e., generally when fabricating. Such feedback may be provided in the form of a feed, a URL, an app, etc).

### 10.9 Variation of Material Detection

While in the disclosure above, the system detected material using one camera, other embodiments may detect material differently: (1) Multiple cameras (2) One or more cameras that can be moved. (3) User input (on a screen, by marking up a camera image, by placing any form of markers on the corners, by moving the laser cutter gantry either by hand or using controls, or similar) (4) Sensors looking at the material from above using distance measurement sensors (time of flight, ultrasonic, laser triangulation, optical, or similar) proximity sensors (capacitive, inductive, hall effect, or similar) touch sensor (mechanical, resistive, or similar). (5) Any from the methods from (4) looking at the material from below. (6) Any from the methods from (4) looking at the material from the side. (7) Any combination of the above

### 10.10 Calibrating Spatial Dependent Features

Some fabrication machines perform inhomogeneously across their cutting volume (discussed in PCT/US2023/012244 at the example of Kerfmeter): in one corner, for example, the device may require additional power to cut through. The same concept applies to other properties, such as cutting power, engraving/marking power, kerf, material thickness, cutting power, box joint, cross joint, or any of the other gauges listed above.

Some embodiments may thus offer performing the calibration process described above not just in one location, but repeated across the cutting volume. The system may always do this, do it based on past data, from-time-to-time, on user request etc. A user interface may be as simple as picking from a standard set of standard layouts, such as {1, 2, 4, 6, 9, 16, 24, . . . fill entire cutting material sheet}. FIG. 39 illustrates this.

Some embodiments will run these replicated gauges in fully redundant fashion, while others may only run the first one or few in full resolution and then run the others so as to search the space already narrowed down by the first gauges.

The system then interpolates values across the cutting volume and applies the interpolated value locally.

### 10.11 Gauges on the Material Sheet vs. on the Edge of a Sheet

While in the disclosure above, the system executed gauges that are fully contained within the material, other embodiments may instead use gauges located at the edge or a corner of the material, reducing the number of lines that need to be cut, thus allowing for faster execution. This also reduces the risk of element of a cutting gauge jamming and thus erroneously not dropping.

### 10.12 Automatic Nesting/Manual Nesting

While in the disclosure above, the system determined the location of parts and gauges automatically, other embodiments may use manual placement of gauges and/or parts, or semi-automatic placement, e.g., supported by the system making suggestions for placement.

### 10.13 On Other Subtracting Technologies, Such as Milling

While the above disclosure so far focused on laser cutting, the same approach applies to other subtractive methods as well. The gauges may need to be adjusted though to match the different technology though.

So far, we have referred to gauges (primarily) for laser cutting. However, some embodiments may support other fabrication technologies, such as milling. Many of the gauges presented gauges presented for laser cutting transfer well, e.g., to milling: thickness gauges remain the same. Box joints gauges remain the same. Cutting power gauge turns into Z-depth of the mill bit, in addition driving speed of the mill. For milling users may choose to calibrate not only per material, but also per tool×material. Kerf calibration remains essentially unchanged (same as kerf+fit on a laser cutter, as discussed earlier and in PCT/US2023/012244). Others may need adjusting, e.g., (1) Calibrate propulsion (German: “Vortrieb”) by increasing propulsion until the quality of the cut decreases (or, worst case, the mill bit breaks, which is then replaced). There are also miter cuts and a large range of different joints, that may need to be calibrated.

### 10.14 Projector

Some embodiments may also employ a (short-throw) projector in the fabrication machine, set up to project onto the workpiece.

This allows showing messages to the user, point to parts and gauges, and (combined with the aforementioned camera) to touch enable the work piece, show progress and previews or what will be cut next and where, suggest users move the material sheet to use the localized qualities of the cutter, point to the gauge to evaluate, where to place weights to prevent a material from buckling, etc.

### 10.15 Alternative Kerfmeter Embodiments

Most aspects of what a subtractive fabrication machine does, such as cutting, or engraving, can be readily observed using a sensor, such as a camera or a touch probe etc. This allows our approach to handle a lot of dimensions of calibration by cutting/engraving a little bit, observing the result using a camera, comparing the result to the desired result (such as the optimal tradeoff between successful cutting and minimum burn marks), adjusting settings or model, and then repeating the procedure until the results are within some acceptable distance from the desired optimum.

One of the main exceptions is engineering fit, i.e., how two or more fabricated parts fit together when they are combined to form a composite model, such as a larger flat model (e.g., using butterfly joints) or a 3D model (e.g., using box joints, cross joints, T-joints, etc.). When fabricating such a model, we would like to cut it with the model dimensioned such that resulting joints will have just the right amount of interference for the material and user intent at hand. We thus want to know how to dimension the model so as to give us the desired force to assemble the model, and/or the desired force to disassemble the model, and/or the ability to take a tensile load—before fabricating starts.

These mechanical properties, however, depend on a number of factors, such as the over-lap between parts (aka interference), which is affected by how much material the fabrication device removes during cutting (aka kerf), as well as by how much the material resists deformation (aka stiffness or compliance).

The challenge here is that joints tend to be assembled (1) by hand and (2) after subtractive fabrication completes. The information on how well the joints fit would have been relevant for picking the parameters for the subtractive fabrication process (such as by how much to dilate the model to obtain the right fit); however, it comes too late.

The essence behind the various Kerfmeter embodiments disclosed in PCT/US2023/012244 is therefore that they essentially produce a sample of a joint (2) before the fabrication of the actual model takes place and (1) that they fabricate and test it in an automated fashion. The variations disclosed in PCT/US2023/012244 do without ever sensing kerf or stiffness in isolation, but by creating a “prototype” of a joint. This allows them to try out which model dimensions (with kerf still subtracted from it) produces the best results.

Now, it is certainly possible to (2) fabricate the parts that make actual joints before fabrication of the actual model starts, and (1) to assemble such actual joints, e.g., using a robot arm or a pair of robot arms or similar technology (such as any machinery used to assemble objects today, such as in the car industry, or any other industry that mass produces assembled goods, etc.), and then outcome could then also be assessed automatically, such as by (using strain gauges, cameras, etc.) to sense the resistance that robot arms encounter, while forcing parts into each other, and this approach is also part of the present invention.

The various Kerfmeter embodiments from PCT/US2023/012244 aim to simplify this process by describing combinations of joints and matching machinery that are designed to allow assembling and testing of joints using a reduced hardware effort:

While the Kerfmeter embodiments tend to focus on joints that are flat in the plane of the workpiece, other embodiments may tilt one or more of the involved parts to produce 3D joints, e.g., to test T-joints more literally.

So far, we have focused on driving a Kerfmeter by testing different/increasing amounts of force/torque, with the inset's orientation (or position) serving as the observable result. Alternative embodiments may take the opposite approach, which is to drive the device to a given orientation (or position), with the required force/torque serving as the observable result.

As discussed earlier, most embodiments cut a part from the workpiece and force it into the remaining workpiece, while other embodiments force a part of the device itself into the workpiece, such as a prong, or more generally any type of probe.

So far, we have focused on Kerfmeter making contact with the workpiece by cutting holes into the workpiece and inserting a set of prongs into it. To make sure the movable inset, such as a spiral, stays in the same plane as the remaining part of the workpiece, some embodiments may choose to actively align the inset with the workpiece, e.g., by pushing both against the surface they are located on. Some embodiments may combine prongs and pushing by forcing the prongs into the inset (and optionally other prongs into the remaining workpiece), e.g., optionally simplified by using prongs with a sharp edge.

However, yet another set of embodiments takes a different approach: instead of creating (a variation of) a joint, they sense kerf and/or stiffness in isolation and then determine the resulting effect mathematically.

Some embodiments may sense kerf optically, e.g., using a camera or similar sensor looking at a cut from above (possibly even while cutting, e.g., using a beam splitter, see Schnittspaltbestimmung by Trumpf), from the side (e.g., by cutting through the edge of the workpiece or by cutting it in half later), or from any other angle. Other embodiments may sense kerf mechanically, e.g., using a touch probe.

Placing one or more light sources on the same side as the camera, on the opposite side, and/or on the sides helps control the image quality obtained by the camera. Some embodiments will choose to take multiple images with different light sources to obtain additional information.

Some embodiments determine stiffness/compliance. If stiffness/compliance is sufficiently consistent an embodiment may choose to determine it by determining the material type (which may be part of the model description, entered by user, recognized using a camera or similar (e.g., speckle sensing, Dogan, et al. SensiCut. In Proc. UIST 2021), etc.) and then looking up its stiffness/compliance in a look-up table.

Other embodiments may determine stiffness/compliance by forcing a physical probe into the workpiece (or a slit of hole in the workpiece, e.g., produced prior using the subtractive fabrication machine) using a well-defined force (or a series of defined forces) and measure the resulting mechanical resistance (or series of resistances). The device could be separate from or mounted to the subtractive fabrication device, or, for convenience to the head of the subtractive fabrication device, allowing the software controlling the device to move the device over the respective workpiece (also in case there should be multiple such workpieces). FIG. 40 shows one possible such contraption consisting of a probe 303 mounted to the head of a laser cutter 301 by a force sensing mechanism. This design can be forced into the workpiece using a mechanism belonging to the fabrication machine, such as the actuator moving the table holding the workpiece, or using its own mechanism, such as a linear actuator contained in 302.

Finally, yet other embodiments may sense a combination of kerf and compliance by forcing a probe into a cut or a hole, in which case the ability for the probe to enter the workpiece is determined by a combination of the size of the slit/hole (allowing and the materials compliance.

Given that some subtractive fabrication machines have different kerf when cutting in different directions, some embodiments will choose to perform multiple tests in different orientations.

### 11 NETWORK & INTERNET-BASED USE, REPOSITORIES, AND MARKETPLACES

Enabling calibration is very useful in itself. Still, the present invention goes quite a bit further, in that it creates the basis for exchanging models between people, which in turn produces the basis for (1) sharing, i.e., where a model goes from one person/group/organization to another person/group/organization, as is the case when sending files, by a storage medium or a network, the internet, by uploading/downloading from a repositories, through third parties, etc., to enable someone down the line to fabricate the model, as well as (2) delegating work (orders, contract work, business, marketplaces, with or without payment), where a model is being shared conceptually similar to (1), but where the resulting physical artifact is expected to go back to the first person/group/organization. (In the following, we will at times use the term “sharing” to refer to both of these scenarios).

The key observation is this: in order allow (1) sharing to work, the model has to come with all the information required to make it “work”: whenever there is ambiguity in the model allowing one or more aspects of the model to be fabricated in more than one way, and at least one of these ways running the risk of producing a non-working/dissatisfying result, then the ambiguity should be resolved by specifying which way or which ways are acceptable and/or which ways are not.

A laser-cut plywood chair, for example, needs to be robust enough for a person to sit on it—otherwise it does not “work”. When sharing the model of a chair, the model may therefore specify which type of types of plywood are acceptable, what thickness or thicknesses, how tight the (selected, all, or each individual) joint is supposed to fit (i.e., specify the “engineering fit”, or just “fit”, or define an acceptable force range at with which two parts are to be joined, or what tensile force they are supposed to be able to resist, etc.), whether and what type of glue to use and how, and so on. In order to perform the purpose intended by the originator the chair may require additional details to “work”, such as coating it with lacquer etc.

Note that for a shared model, often, many ways may work. For the chair, for example, birch plywood may be acceptable—so might be beech plywood, etc.

Either way, what is acceptable in the end, is determined by the person eventually fabricating the model. If a person downloading the chair model, for example, chooses to repurpose the chair and make a chair to be placed in a shopping window, then foamcore might be an acceptable material for that new purpose. What makes the “sharing” use case straightforward is that the person/group/organization fabricating the model also commonly is the person/group/organization who will use the model; this allows making the decision on the spot.

This is different when delegating work, i.e., the person/group/organization is delegating the fabrication of a model to another party. The same requirements as before apply here as well, i.e., the person/group/organization sending the model should specify what works. In addition, however, the delegating person/group/organization will often narrow the space of acceptable results down further. This may narrow all choices down to a single possible result, to multiple permitted solutions, or provide a preference ranking, such as “if available, use beech plywood; but if beech should be unavailable, birch is acceptable as well”.

We will refer to this as a specification, defined as “a detailed description or a set of requirements that defines the characteristics, performance, or functionality of something, often used in technical or engineering contexts”. Ideally, this narrows ambiguity down to the point where all decisions that may or may not arise at the contractor's side have been anticipated and made. A perfect specification allows a contractor to always execute the job without stopping.

Looking at the world of subtractive fabrication, especially laser cutting, for example in the field of education and maker spaces, we see that none of this is possible today. The root cause of this is the way models for subtractive fabrication are being shared or delegated today. The most common format in use today for laser cutting, for example, is SVG. As the name suggests, Scalable Vector Graphics (SVG) is a format for defining two-dimensional graphics. When used in its originally intended field of graphics, displaying an SVG containing a bitmap may mean “render pixels of these colors here”. Unambiguous enough. When the same file is sent to a laser cutter, there are many different ways, how the bitmap could be interpreted and thus implemented, including “make the surface covered by a darker pixel darker” and “make the surface covered by a darker pixel deeper.” Lots of ambiguity here.

As a result, a person receiving a model has to fill in the gaps. To stick to the same example, the recipient of the model has to have sufficient domain knowledge to understand that a bitmap in one model is intended to produce a certain look (dark pixels, aka marking), while a similar bitmap in another model may be intended to create a deep grove or slot to form part of a mechanical mechanism. This can require recipients to have significant domain knowledge.

The situation is even worse in the delegation scenarios. First, the receiving party may well know nothing about the application domain of the model they have been sent, such as when a carpenter running a laser cutting service receives an order from an artist, or the other way around. Second, finding out is more effort now, as the two parties may not be collocated, need to find a time slot that works for both, and then (repeatedly) spend time on the phone to resolve potential issues.

The worst case, however, is when the contractor is not even aware of the ambiguity, i.e., the contractor with a background in visual arts may see a model with an embedded bitmap and intuitively respond by implementing it as a pattern of light/dark pixels (marking), not even realizing that the sender might have intended it form a deep grove to be part of a mechanism. In this case, the contractor may fabricate the model, ship it to the person/group/organization that had given the order, who then finds out that the result does not “work”. In the absolute worst case, now a legal battle follows, in which the contractor argues the project was insufficiently specified, while the client argues that the missing knowledge was common sense.

These risks have limited the use of repositories. We also see no efficient marketplaces for subtractive fabrication. This prevents the field from growing.

### 11.1 Specification of Outcome in Other Fields, Such as Print

Other fields have been in similar situations. One of them is print. The breakthrough happened when the field transitioned from describing how to produce a page to specifying what the page was supposed to look like. The result is page description languages (https://en.wikipedia.org/wiki/Page_description_language), such as Adobe PostScript. Page description languages make sense, because they describe what matters to users, and in print that is appearance.

If one enumerates all the elements a sender may want to tell a receiver in order to specify a printed page, the resulting language definition can become large. Adobe PostScript addressed this by including loops etc., thus allowing users to put programs into their page descriptions (e.g., https://paulbourke.net/dataformats/postscript).

### 11.2 Specification of Outcome in Subtractive Fabrication

We now focus on how to share subtractive fabrication models or delegate subtractive fabrication jobs. Historically, this has been done by encoding the model in SVG, which describes how to move a laser head along a path, and (indirectly) how much power to administer. The present invention moves away from describing how to fabricate an object (even though many embodiments will allow for that as well for compatibility reasons). Instead, they describe the outcome in the physical world. They do so using terms that describe the physical world, such as physical properties or a description of what the outcome looks like. Some use physical units (such as SI meter, kilogram, seconds, or imperial units, such as inch or PSI), others have references to the model or the material itself, and yet others allow for both.

### 11.2.1 Engravings/Markings

Unlike the traditional use in SVG, etc., the present invention describes engravings by the desired outcome, i.e., darkness.

Embodiments of the present invention (also) allow describing colors/brightness using units from the physical world. Using syntax that is C-like (other embodiments will use XML-like syntax, or JSON-like syntax, or cutplan-like syntax, etc.; to make this easier to read, we add the ability to express units, such 9 N for 9 Newton) we might write engravingColor=DARKNESS_OF_A_CUT; to allow creating engravings that match and thus cover up the darkness of, say, a box joint. engravingColor=DARKEST POSSIBLE; might be a way to specify to make the darkest the machine is able to produce. DARKEST_POSSIBLE, LIGHTEST_POSSIBLE, DARKNESS_STANDARD_DEVIATION, DARKNESS_STANDARD_ERROR, etc. are ways to specify aspects of a model in terms of the fabrication device's gamut (the complete range or scope of what it can produce).

Most embodiments will choose to use perception-oriented color/luminance spaces, such as a variant of L*a*b or Oklab (https://bottosson.github.io/posts/oklab), which are designed to produce uniform results, meaning that equal distances in the color space correspond to roughly equal perceived differences in color. This makes it easy to do math, such as engravingColor=LUMINANCE_OF_MATERIAL/3, meaning that the engraved material is specified to have a third of the luminance of regular material. Many will choose to also specify what exactly this means, such as reflect one-third of the light, etc.

An underlying mathematical scale helps do math. A wide range of scales will do, such as to describe the scale from light to dark as from 0 to 1, 1 to 0, #00 to #ff, or as a color of which only luminance plays a role, etc., or any other numerical encoding.

Various embodiments will use this to specify the darkness of a range of fabrication styles, such as raster engravings, line engravings, etc.

With a definition of what the darkest value means and a color model that allows for interpolation, we can now go back to using bitmaps, as now the pixels in a bitmap have a defined meaning based on the darkest value and interpolation.

Such a specification can, of course, also be executed by a human, who manually calibrates the fabrication machine, such as a laser cutter, to produce such values. The key element to make this work efficiently is, of course, the methods and apparatuses described earlier in this disclosure, i.e., when a model with engravings of perception-oriented darkness is received, the semi-automatic or semi-automatic calibration process calibrates for it, i.e., determines the mapping from the specified values (such as power, speed, focus, etc.) to the parameters the subtractive fabrication has to use in order to produce these values.

### 11.2.2 Cutting and Engraving for Depth

Similarly, the present invention allows specifying the outcome of depth engravings or cuts in units that specify the result in the physical world, such as engravingDepth=2 mm; or cuttingDepth=MATERIAL_THICKNESS/3; or cuttingDepth=MATERIAL_THICKNESS−PAPER_THICKNESS; to cut through the paper and foam layer of a paper-foam-paper sandwich material, etc.

Again, the specification can be executed by a human, who manually calibrates the fabrication machine, such as a laser cutter, to produce such values. But again, many embodiments will instead use a semi-automatic or fully automatic calibration process for it (e.g., measuring depth using a touch probe or camera), i.e., it determines the mapping from the specified depth values to the parameters (such as power and speed etc.) the subtractive fabrication has to use in order to produce these values.

### 11.2.3 Structural/Static and Mechanical Performance, Joints

Similarly, the present invention allows specifying the outcome of joints, such as box joints (aka finger joints), T-joints, and cross joints. A key property of these joints in the physical world is the force that the joint requires to assemble.

boxjointAssemblyForce=9 N; or boxjointAssemblyForce=MALLET_IMPACT_TIGHTNESS;// so tight that can only be assembled with the help of a mallet. boxjointAssemblyForce=DECORATIVE_TIGHTNESS;// quite loose, barely holding together, do not touch once assembled. boxjointAssemblyForce=ADULT_MANUAL_TIGHTNESS;// As tight as a typical human can assemble by hand. Similarly, users may instead specify boxjointDisassemblyForce=4 N;// tension force required to take apart.

Since the length of the pins or slots of a joint reflects the material thickness, many embodiments will specify the length of the pins and/or slots in terms of mathematical expressions involving MATERIAL_THICKNESS (e.g., some existing formats, such as LaserSVG and MetaSVG, allow for this).

### 11.2.4 Assertions

The machinery or material of a receiver of a model or a contractor, etc., may not be capable of producing a useful file. To help prevent the fabrication of physical objects that then end up not “working”, some embodiments will allow specifying that as well, such as assert(MATERIAL_THICKNESS>=5.9 mm); assert(MATERIAL_STIFFNESS>=7000 N/m); Some embodiments will allow users to override assertion fails and still push the fabrication through.

Note that this way of specifying models ideally makes reference only to the outcome, but not to the machine performing the job. This may give a person receiving a model or a contractor, etc., the chance to not only implement some aspects of the model in a way different from what the model's designer had in mind, but may even use an entirely different fabrication methods or machine, such as a milling machine, when the client has a laser cutter in mind—or the other way around.

### 11.3 Entering the Specification, e.g., Using an Editor

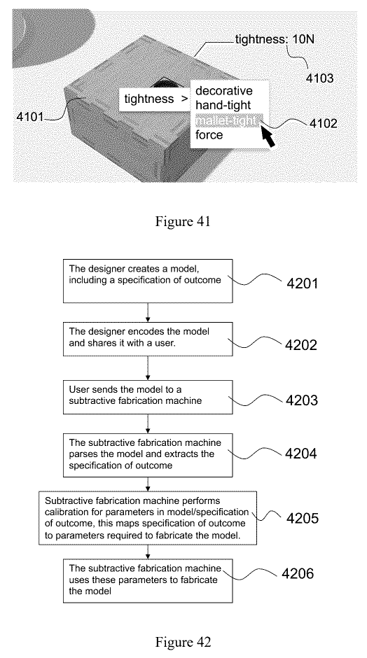

In its (for the system) simplest form, users may write or modify model files by hand, e.g., using a text editor. In order to offer more convenience, more embodiments will offer conversion tools (such as tools wrapping the algorithm guessing the material thickness, described earlier) and others will offer interactive editors. FIG. 41 illustrates this at the example of an interactive program. At the shown moment, the user has clicked on a joint 4101, the system has responded with a pop-up menu, and from the pop-up menu, the user is about to select “mallet-tight” 4102 to adjust the tightness of the selected joint. Other embodiments may use other interaction techniques to specify such values, such as verb-noun tools, etc. Yet other embodiments may offer ways to display the current settings 4103 (some of which might be interactive etc.).

Various embodiments may allow users to edit any of the properties discussed earlier and others. Some embodiments may also allow users to specify alternative choices, e.g., by allowing them to pick multiple values, or even rankings of choices, or utilities, and tradeoffs.

### 11.4 The Resulting Workflow

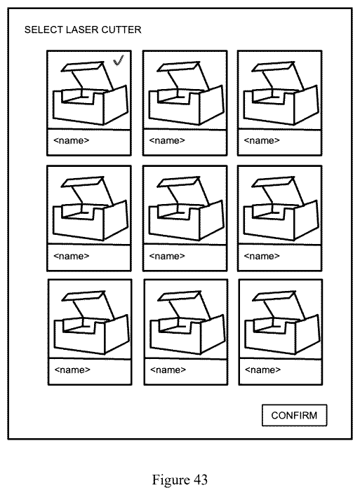

FIG. 42 shows the resulting workflow for sharing a model, in which the “specification of outcome” is the key element that allows the workflow to complete in a fully automated fashion and without requiring user expertise.

The process starts with the designer creating a model (or picking an already designed model), including a specification of outcome 4201. The designer may be one of more people using an interactive editor, such as illustrated by FIG. 41 or any other such system, such as kyub, flatFab, autoCAD, Rhino, etc. or any other 3D editor combined with a conversion tool that allows exporting for subtractive fabrication machines, such as Platener (Beyer, D. et al. Platener: Low-Fidelity Fabrication of 3D Objects by Substituting 3D Print with Laser-Cut Plates. In Proc. CHI 2015, pp. 1799-1806). The designer may also be a computer program, such as, for example, an artificial intelligence. The designer may enter the specification of outcome using a 3D editor enabled with such functionality, or the designer may be running the model through a separate tool that allows entering additional specification of outcome.

Now the model designer shares the model by encoding it in a file (or data structure or stream) and a user receives or downloads the model 4202. Designer and user may also be the same person, which implements a non-collaboration scenario of a user simply designing and fabricating a model. In case the designer and user are the same person, step 4202 is left out and it is now the designer who sends the model to the subtractive fabrication machine in the next step.

The user now sends the model to the fabrication machine 4203, which, of course, contains a calibration subsystem, as described throughout this disclosure). It parses the model and extracts the specification of outcome 4204. The subtractive fabrication machine now performs the calibration for the parameters in the model/the specification of outcome 4205. This maps the specification of outcome to the parameters required to fabricate the model.

Finally, the subtractive fabrication machine uses these parameters to fabricate the model 4206, resulting in a model that fulfils the specification of outcome.

The process of delegating fabrication proceeds in analogy to the sharing workflow described in FIG. 42, but here the designer might be called customer and the workflow has an extra step at the end, which is to send the model to the customer.

The delegation process may also involve a separate cost and/or duration/shipping date computation step, e.g., during step 4204, in which the subtractive fabrication machine parses the model and specification of outcome. Both may contribute to cost and duration, e.g., by the model determining the amount of material to be used and paid and whether it is in storage, while the specification of outcome might, for example, describe what type of material to be used and paid (and whether that is in storage).

The cost may at this point be shared with the customer. The workflow may then end (in case the customer's objective was to only obtain an offer) or it may continue, e.g., after the customer has agreed with the conditions, such as cost and shipping date.

### 11.5 Resulting Scenarios Enabled by This Workflow

This way (semi- or fully automated) calibration and the involved methods create the basis for exchanging models between people/groups/organizations. This exchange may take place in the same office or lab or across distances. While we described our system as being run with one laser cutter (or similar machine), such scenarios support multiple machines and across machines (as to some extent mentioned in PCT/US2023/012244).

(So far, we described Kalibrator as being run with one laser cutter (or similar machine) that is more or less collocated. Alternative embodiments may (also) support cutters located at a distance, connected by any type of network, such as, but not limited to (Internet, TCP-IP, UDP, email, services, or even by physical mail, such as by shipping a storage medium, such as SD card, hard drive, flash memory, tape, etc.). The individual cutters may then offer any combination of semi-automatic, automatic, or manual calibration, as these are generally compatible with each other.

When users decide to fabricate a model, they may pick a fabrication machine to send the model to. Some embodiments may use a user interface such as the one shown in FIG. 43, which is structurally similar to how users pick a (network) printer. Note that such a dialog may mix local machines, machines at a distance, machines from the (social) network, and also the machines of commercial vendors (see below). The shown interface dialog may be prepopulated with a default machine, such as the fabrication machine used last time.

Some embodiments may allow users to choose, others may delegate to the system, which picks the best cutter for the job at hand based on aggregating cost, quality, shipping time, load balancing, maximization of machine time, job broadcasting, selection by the laser cutters themselves, etc. Some embodiments may allow subdividing and distributing larger projects across multiple cutters. Some embodiments may allow assigning models to cutters on a per-part basis (highest amount of control), per-sub-assembly basis (e.g., when combined with roadkill Roadkill: Nesting Laser-Cut Objects for Fast Assembly. In Proceedings of UIST '21, 972-984), per-model basis (minimizes effort for collecting all parts of a model when done cutting), or per-material basis (minimizes calibration effort), per-quality basis (minimizes cost for material by using the best cutters and/or best materials only where necessary), or any other criterion.

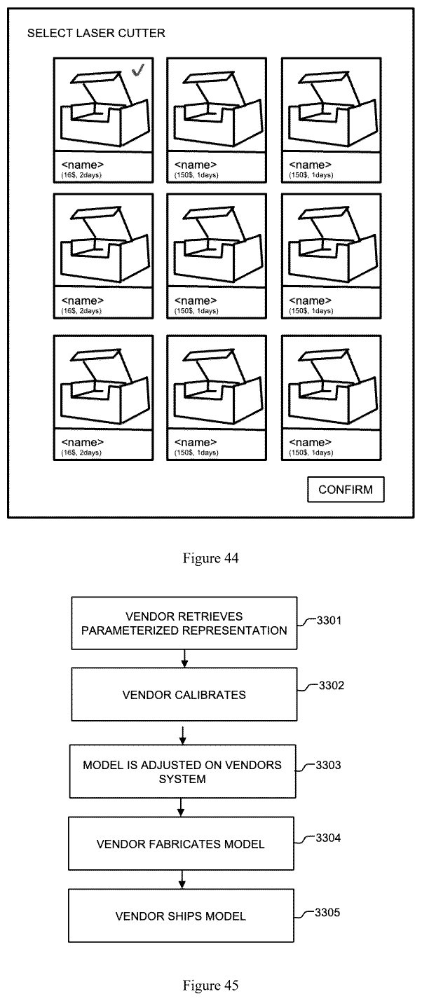

So far, we often focused on a system being run on laser cutters owned by the person cutting. Embodiments belonging to the “delegation” group of scenarios, however, may include laser cutters that are owned and/or operated by others, such as vendors. FIG. 44 shows one such scenario, where cutters of (multiple) vendors show up in the laser cutter selection interface, either exclusively or mixed with local cutters. Note how some embodiments may allow vendors to provide a price/cost estimate as described earlier. In addition to the usual criteria (cutting time, material, etc.), pricing may or may not take calibration effort (time, material) into account. Some embodiments may feature price, e.g., determined using the algorithms presented earlier. Some embodiments may also offer utilization or demand as one of the factors for calculating cost estimates. In some embodiments, vendors may choose to include potential shipping costs in the price estimate, while other embodiments may list these costs separately.

The system architecture and user experience of such a system largely derive from any other online shopping/brokering system, such as amazon.com or uber.com except that the model to be cut has to be transmitted to the vendor (using any of the channels listed earlier: (a) send the actual model(s), (b) send a handle to model(s), (c) provide access to the model(s) through a centralized server, (d) provide access to the model(s) through a decentralized method (blockchain etc.), etc.).

Universal (semi or fully automated) calibration forms the basis of this (replacing today's process of a long, drawn-out human-to-human process). There are multiple ways to perform this, including (a) calibration being applied at the user's/customer's site (based on calibration info sent by the vendor) or, even easier, (b) calibration is applied at the vendor's site—the user only sends the model as discussed earlier, or reduced to just the use of calibration (as opposed to the more elaborate specification of outcome), shown in FIG. 45.

In this reduced approach, files sent to the vendor may still be encoded in any of the formats discussed throughout this disclosure: a 3D format, such as kyub, flatFab, Onshape, Auto-CAD, etc., allowing the vendor to run the 3D to 2D pipeline described throughout this disclosure, or an adjustable 2D format (LaserSVG, metaSVG, cutplan) which the vendor adjusts after calibrating, or a non-adjustable 2D format (SVG, OBJ, GCODE, etc.) which the vendor pipes through 3D reconstruction as discussed earlier, or just the reconstruction of parts vs. scrap, material thickness, joints, etc.

Alternative embodiments of our system may also include a software receiver connected to the laser cutter, allowing them to send and receive a serialized data structure rather than an encoded data format.

Some embodiments of the present invention may provide a communication channel across which users/customers send models to vendors. Other embodiments may also allow users to ship their preferred physical materials to be cut from to the vendors. While some embodiments may simply facilitate communication between customer and vendor about this, other embodiments may support it by providing shipping labels and custom cost estimates for these cases.

What is claimed:

1. A calibration subsystem comprising:
a control system that provides a control signal to a fabrication machine to process a sample of a workpiece;
at least one sensor sensing the state of the sample after being processed,
wherein the control system computes the difference between the sensed effect and a desired effect;
and the control system, in accordance with the difference, updates settings of the subtractive fabrication machine and/or of one or more models to be cut subsequently.

2. The apparatus of claim 1, wherein
the control system repeats the processing, sensing, difference-computation, and adjusting, until the difference between the sensed effect and the desired effect is below a given threshold.

3. The apparatus of claim 1, wherein
some samples are positioned to be located over an opening in the surface the workpiece is resting on, so as to allow them to drop once cut out.

4. The apparatus of claim 3, wherein
the control system determines whether the workpiece was cut through,
by sensing whether the sample has fallen through an opening in the surface.

5. The apparatus of claim 1, wherein
at least one sensor senses the state of the sample or workpiece after being processed and the control system updates the settings in response to sensed burn marks.

6. The apparatus of claim 1, wherein
the processing is an attempt to cut through the workpiece,
at least one sensor determines whether the material was cut through,
and the control system updates the settings for cutting power and/or cutting speed.

7. The apparatus of claim 1, wherein
the processing is a raster engraving intended to change the darkness of the workpiece sample,
at least one sensor senses the darkness of the sample,
and the control system updates the settings for engraving power and/or speed and/or focal distance.

8. The apparatus of claim 1, wherein
the processing is a raster engraving intended to change the depth of the workpiece sample;
at least one sensor measures the depth of the engraving at the sample or the thickness of the remaining material;
and the control system updates the settings for engraving power and/or speed and/or focal distance.

9. The apparatus of claim 1, wherein
the processing is a line-engraving intended to change the darkness of a line segment on the workpiece sample;
at least one sensor is capable of sensing the sample's darkness;
and the control system updates the settings for engraving power and/or speed and/or focal distance.

10. The apparatus of claim 1, wherein
the processing is a line-engraving intended to change the depth of a line segment on the workpiece sample;
at least one sensor is capable of sensing the line on the sample's depth;
the settings to be updated are engraving power and/or speed and/or focal distance.

11. The apparatus of claim 1, wherein
the processing is an attempt to cut through the workpiece sample;
at least one sensor determines kerf by measuring the width of the cut slit;
and the control system updates models' dimensions so as to compensate for the measured kerf.

12. The apparatus of claim 1, wherein
the processing is a cutting operation that produces a part fully separated from the work-piece;
the calibration subsystem furthermore comprises an actuator that forces the separate part into the remaining workpiece;
at least one sensor capable of determining fit as the change in the spatial relationship between part and remaining workpiece;
and the control system updates models' dimensions so as to compensate for the measured fit.

13. The apparatus of claim 1, wherein
the calibration subsystem further comprises an actuator that forces a probe into the remaining workpiece;
at least one sensor capable of determining material stiffness as the change in the spatial relationship between the probe and remaining workpiece;
and the control system updates models' dimensions so as to consider the measured material stiffness.

14. The apparatus of claim 1, wherein
the processing is a cutting operation that produces a part fully separated from the work-piece;
the calibration subsystem further comprises an actuator that forces the separate part into the remaining workpiece;
at least one sensor capable of determining fit as the change in the spatial relationship between part and remaining workpiece;
and the control system updates models' dimensions so as to compensate for the measured fit.

15. The apparatus of claim 14, wherein
the part fully separated from the workpiece is an Archimedean spiral;
the actuator applies torque to the Archimedean spiral;
and the sensor determines the spiral's change in orientation.

16. The apparatus of claim 1, wherein
at least one sensor senses the material thickness at the sample;
and the control system updates the lengths of selected joints' pins and/or the depths of selected joints' slots to reflect the sensed material thickness.

17. A calibration subsystem comprising:
a control system that provides a control signal to a fabrication machine to process a sample of a workpiece;
the control system offering an interface that allows users to enter the state of the sample after being processed;
wherein the control system computes the difference between the sensed effect and a desired effect;
and the control system, in accordance with the difference, updates settings of the subtractive fabrication machine and/or of one or more models to be cut subsequently.

18. The apparatus of claim 1, wherein
the fabrication machine holds multiple workpieces;
the calibration subsystem executes the processing, sensing, difference-computation, and adjusting process, on one or more of the workpieces.

19. A method for fabricating a model on a subtractive fabrication machine, the method comprising
uploading a model intended for fabrication;
the control system analyzing the model and identifies what calibration the model requires,
running the identified calibration;
fabricating the model.

20. A method for selecting a subtractive fabrication machine from a set of available machines, the method comprising
uploading a model intended for fabrication that includes a specification of outcome;
receiving performance estimates for fabricating the model on the respective machine, based on model, the machine, and the available materials.

21. A method for connecting a client with a laser cutting service provider, the method comprising
sharing a client's models that includes a specification of outcome with the service provider;
receiving the service providers' offers based on the model.
